(19) United States
(12) Patent Application Publication
(10) Pub. No.: US 2024/0267681 A1
(43) Pub. Date: Aug. 8, 2024

(54) BONE-CONDUCTIVE AUDIO SYSTEM

(71) Applicant: Michael Godfrey, Toronto (CA)

(72) Inventor: Michael Godfrey, Toronto (CA)

(21) Appl. No.: 18/435,332

(22) Filed: Feb. 7, 2024

Related U.S. Application Data
(60) Provisional application No. 63/595,574, filed on Nov. 2, 2023.
(60) Provisional application No. 63/444,099, filed on Feb. 8, 2023.

(51) Int. Cl. H04R 25/00; H04R 1/10; H04R 5/027

(52) U.S. Cl. CPC H04R 25/405; H04R 1/105; H04R 5/027; H04R 25/402; H04R 2225/31; H04R 2225/61; H04R 2460/13

(57) ABSTRACT

A bone-conductive audio system includes at least one head-worn hearing enhancement apparatus. The head-worn hearing enhancement apparatus comprises a microphone in front of the outer ear generally picking up sound in a forward outward direction and at least one microphone behind the outer ear picking up sound in a more rearward outward direction. First and second amplified vibration transducers interact with the at least one microphone in front of the outer ear and the at least one microphone behind the outer ear. The first and second amplified vibration transducers are drawn toward audio conductive bones. Placement of the at least one microphone in front of the outer ear and the at least one microphone behind the outer ear feeds the naturally captured discrete audio signals, front and rear, captured in a physical location on the head to the first and second amplified vibration transducers to create organically recognizable audio spatiality.

### CROSS REFERENCE TO RELATE APPLICATIONS

This application claims the benefit of U.S. Provisional Application Serial Nos. 63/595,574, entitled “BONE-CONDUCTIVE AUDIO SYSTEM,” filed Nov. 2, 2023, and U.S. Ser. No. 63/344,099, entitled “HEAD-WORN HEARING ENHANCEMENT SYSTEM WITH IMPROVED SPATIAL AUDIO SOURCE LOCALIZATION,” filed Feb. 8, 2023, both of which are incorporated herein by reference.

### BACKGROUND OF THE INVENTION

### 1. Field of the Invention

The present invention generally relates to audio systems. In particular, the present invention relates to bone-conductive audio systems allowing a user to localize the direction from which a sound source is coming.

### 2. Description of the Related Art

In current hearing aid technology, there are three basic types to consider: “In-ear,” where a plug goes inside the ear to block out external noise and where a microphone is placed on the outside of the device in the ear facing outwards so that its audio can be electronically processed and fed into the ear canal. Another type of hearing aid is called “behind-the-ear” where the body of the electronics and in addition to a microphone are placed behind the outer ear pinnae and a small tube or wire is fed from the behind-the-ear device. This tube contains the audio signal derived from a transducer directly to the ear canal, thus providing sound to the ear. In this instance, the microphone is generally located behind the outer ear flap (pinnae). When the microphone is located behind the outer ear structure it is actually a barrier for sound transmission and not in a very good position to acquire sound in a natural way. These types of hearing aids actually bypass the ear structure and its functional abilities in a negative way. The third major type of hearing aid is the “bone-conductive” type which creates vibrations via a transducer placed on the surface of the head; usually the part of the temporal bone, the bone that surrounds the outer ear).

Referring to FIGS. 19 and 20, the ear is an amazing instrument. It is a mass of specifically shaped skin, nerves, cartilage, and bone that has evolved to enable humans and other animals to gather environmental information that, when processed by the brain, is necessary for communication, interaction with and enjoyment of the environment, and basic survival in most aspects of life. The special folds in the shape of the outer ear collect acoustic information from the surrounding environment in the form of sound waves. Externally generated sound waves are organically filtered for selective frequencies by the outer ear and eventually brought via the ear canal into contact with the eardrum and other parts of the middle ear. The parts of the middle ear convert the acoustic energy into nerve impulses that are sent along the vestibulocochlear nerve to the brain. In a normal person, and most animals, the ears on both sides of the head work together at this job. Together they simultaneously process information from the surrounding environment that is necessary for us to locate sounds and their origins in space. This enables us to communicate with others in our environment, and to keep us safe and out of danger.

When a part of the hearing mechanism is not working properly this can lead to hearing impairment or deafness. Hearing aids are available in many forms and at many price points in the marketplace. Traditional hearing solutions have been around for years and have evolved immeasurably: from a time when a hollow horn was physically placed over the ear to amplify sound to very sophisticated, miniaturized and technologically advanced electronic devices that are currently available. These assistive hearing devices can sit inside the ear canal or sit behind the ear, and are designed to help with a person's specific hearing loss condition. These solutions usually concentrate on amplifying sounds gathered by a microphone included on the apparatus that plays back the amplified sound simultaneously into the ear canal at an amplified level. These systems, though beneficial in many ways to the listener, by design, in most cases completely block the ear canal from the passage of any natural acoustic information, as the hole into the ear is blocked by the device itself. When they are used, any remaining ability of the user to locate sound sources is significantly diminished as the device itself is blocking not only the ear canal but other parts of the physical outer ear. Ironically, these devices actually negatively manipulate the acoustically filtered information that has been modified by the outer ear which is naturally supposed to provide users with this acoustic information. If the impaired person has damage or deformity to the middle ear components and has lost their hearing due to this impairment, these in-ear-canal devices do not always work properly and may actually reduce hearing ability to some degree.

Beyond the ear, there are other ways that sound waves are perceived by humans. It is known that sound transmission via bone conductivity is one way. If we tap on our heads with a finger, we hear it and we feel it. If we touch our pinnae (outer ear) very softly we hear it and we feel it too. We know that very loud sounds can feel like wind on our face and “blow us away”. These things suggest that we actually FEEL sound and do not just hear it.

Another form of hearing assist that has been used for decades, and is briefly discussed above, is known as bone-conductive or bone-anchored hearing aids. These types of hearing aids use a vibration transducer either located on and in contact with the skin above the facial bones, or physically (surgically) attached under the skin, to the bone that surrounds the ear. Cochlear implants function similarly in this way as well. Consumer headphones are also known to be made that utilize bone-conductive technology and they are effective at transmitting sound through the head via vibrations in the skull.

Though bone-conductive or bone-anchored hearing aids were an improvement over earlier technologies for certain types of hearing loss, all of these types of hearing aids (which represent, pretty much, every type of hearing aid currently known) have drawbacks to a wearer in several ways. Most specifically, the problems for a hearing aid wearer relate to the audio localization of sound sources in three-dimensional space. This is a very large problem for users; if one can't localize sound sources properly then that person will have a difficult time being in crowded and noisy environments, and discerning where a voice or sound is coming from in that space. Traffic also becomes dangerous and discombobulating as the person cannot hear where vehicles are coming from and in which direction they are going. People normally use this internal directional assessment capability to discern the audio cues that occur in life that enable us to function normally in noisy environments. When the ability to hear is lost, even in one ear, a person's ability to locate sound sources in three dimensions is lost too.

Audio localization is the number one complaint amongst wearers of hearing aids, and most of the complainers do not actually even know that localization is actually what they are complaining about. Beyond comfort issues, hearing aid users mostly complain of having trouble in louder confusing environments with multiple conversations or other sound sources. While wearing a hearing aid, the person is trying desperately to be able to FOCUS on a specific person in this loud environment and finding it near impossible. They do not realize it, but this is actually a complaint about audio localization itself. They have lost the ability to use their ears for this function and by plugging the ear they are wearing a device that actually further hinders the natural processes of the body that could help them “hear.” Manufacturers try to continually address this issue with electronic filtering or electronic signal processing; attempting to update the same devices and designs in the same form factor again and again—to little avail. Almost all of the solutions involve electronic signal amplification, filtering, and frequency isolation. They can be fairly effective solutions to some degree but there is marked room for improvement in this regard as well as increases in comfort and performance.

When a person's hearing is compromised either in one ear or in two, the ability to localize direct sound sources in an ambiance or three-dimensional environment is lost or severely compromised. As can be understood, this affects the person in many ways, some of which can be dangerous. In conversations or in crowded noisy places where multiple audio sources exist, a person does not have the ability to localize a sound source, to tell who is talking amongst many voices or to focus on a particular sound. All sounds seemingly arrive confusingly all at once to the listener's brain. These sounds can be discombobulating too. In street traffic situations in particular, one cannot hear which direction a car is coming from unless the car is being seen directly: not good if the person is facing the opposite way and crossing the street.

Humans (and most other animals) need to know where the sound originates from in order for our brains to focus on it in order to function normally in many aspects of life. This audio localization ability for many people has been lost and has become a disability.

It is known that human beings are able to locate sounds around us in a by focusing subconsciously on a narrow band of frequencies, generally known to be between 1 kHz and 4 kHz. Sounds within this frequency range are thought to be related to the noises associated with communications in the animal kingdom such as bird noises and human speech. We have been biologically evolved to be aware of and to locate sounds, especially within this audio frequency range so that we, as evolving animals, could locate prey when hunting, be alerted to imminent danger, and other sounds like falling water within our midst.

Referring to FIG. 21, sound has been proven to be localized by a process of the brain that determines where sound comes from called HRTF or Head Related Transfer Function. This is a binaural (two ear) audio cue detection system that relies on the shape of the head to act as a barrier between the two ears, located on either side of the head. In simplest terms, the sound arriving on one side of the head takes a shorter time to reach the second ear. This delay is somewhere between 6-10 milliseconds depending on the size of a listener's head. This difference in time (delay) results in a calculation by the brain which perceives through this process where the sound source comes from. There is also the enhanced ability of the brain to recognize sounds in the range of 1-4 kHz. The soundwaves are generated outside the ear and focused by the structure of the pinnae to the ear canal. This triggers the inner ear to react with the vestibular (balance) system which sends physical location messages via nerves to the brain on both sides (left and right) simultaneously, which gives people their sense of space.

Once this hearing/balance system is broken in some way, or the signal is blocked on either side or in either ear, the natural ability to locate sound sources in space is compromised.

Due to the partial or total blockage of the ear canal caused by the modern hearing aid apparatus itself, this phenomenon also occurs to some degree when wearing standard headphone earbuds—even for a person with normal hearing. This can be especially dangerous for any headphone wearer—in traffic for instance, as the device is itself compromising the brain's ability to determine the location of sound sources. Some consumer headphone manufacturing companies are already putting microphones on the outside of the earbuds in a quasi—“hearing aid” manner. The audio captured by the microphones is meant to be heard back “live” to the headphone speaker located in the wearer's ear canal. This mode is usually called “transparency mode,” or similar. Thus, the market has validated the problem and is attempting to find a solution to it.

In a nutshell, headphones, earbuds, and many in-ear-canal hearing aids, when worn in the ear, actually reduce the users' ability to utilize their own ears to hear naturally. By plugging the ear canal and reducing any incoming information, they make the wearer completely reliant on an electronic device to hear anything. Many of these current devices actually block the whole ear canal and completely block any actual acoustic audio derived from our natural capture apparatus—the physical outer ear and pinnae.

Referring to FIG. 22, the shape of the pinnae is also designed specifically to filter incoming soundwaves in a higher frequency and focus them on the eardrum. These filtered, higher-range frequencies that are necessary for audio localization to occur are also blocked when inserting a device in the ear canal.

Many wearers of earbuds or hearing devices that go into the ear also find them to be quite uncomfortable when worn over periods of time.

To summarize, the outer ear (pinnae), its' surrounding bone structures, and the associated nerves in this area has more to do with audio localization than was previously thought, it is not just HRTF! !

As a result of the inability of the brain to use only one ear for HRTF to function properly, single sided deafness (Unilateral Hearing Loss) also results in an almost total inability to know the incoming direction of an ambient sound source.

As a single ear—deaf person with a ruptured ear drum (now with only 10% hearing in his right ear and who had near-perfect hearing previously), the Applicant had a severely compromised ability to locate sound sources. Crowd sounds and conversations were very difficult to process. Life was very confusing. Applicant also had tinnitus or ringing in the ear, 24/7 that drove him crazy. Over the two years of Applicant's hearing-loss experience, Applicant noticed his working ear and brain kind of re-learned where sounds came from by using incoming volume differences from a sound source to approximately ascertain sound source location. This has somewhat improved over time and although it would never be as good as having two working ears, Applicant was now in a unique position to experiment on how to improve auditory localization because Applicant could reference his good ear and past audio experience for comparison purposes. Applicant then utilized his previous career knowledge (that is, a specialty in three-dimensional Audio) to concentrate on a solution. Applicant noticed in earlier experiments with sound and the ear itself that in addition to HRTF there were at least two areas of the outer ear that contributed to audio localization. When mid to high frequency sound sources were played back via headphones and with the speaker placed on different areas of the outer ear, it was discovered that when physically moving the earbud that was playing back the sound (and with eyes closed), the sound source appeared to move front to back on that side in conjunction with the physical earbud movement. The area behind the ear and the area on top of the pinnae (known as the Helix) contributed to the “audio-coming-from-the-rear” sensation. The Tragus area at the front of the ear, when stimulated by the earbud, contributed to an “audio-coming-from-the-front” sensation.

During a tympanoplasty operation that Applicant eventually had in an attempt to repair his ruptured eardrum, the ear was surgically cut into at the area at the back of the ear in order to gain access to the inner ear to repair the hole in the tympanic membrane from behind. The tragus area in the front of the ear was also cut into to remove some cartilage which was used for the eardrum reconstruction process. The surgery was a success, and Applicant's hearing is slowly returning to his right ear. Post-operatively, the first thing Applicant noticed beyond the pain is that the sensation and feeling had been cut to the Helix and to the Tragus. The nerves were severed to some degree as part of the surgery and Applicant had absolutely no physical feeling whatsoever in the outer ear. Applicant also had very little hearing post-operatively for a period of time; worse after than before the operation. (which has now improved with time).

During recovery, in order to gauge Applicant's ability to hear audio in his deaf ear, audio experiments were made on his right (compromised) ear with headphones and earbuds of different types, including bone-conductive headphones. The earbuds did not work very well (very low sound output for his condition—inaudible). Over-the-ear headphones were not much better. Bone-conductive headphones worked the best. Audio sent via vibrations to the bones in the head actually bypass the outer ear ‘sound collection system” (and eardrum) and are tied in directly to the cochlear nerve via the temporal bone.

Since there was no sound incoming naturally for the bad ear, the applicant also tested the output of a multi-channel three-dimensional audio capture device, a Holophone or Global sound microphone system as described in U.S. Pat. No. 5,778,083. Applicant used the outputs of the combination of a plurality of the microphone elements located on the right side of the microphone (as the audio input to compensate for Applicant's bad right ear). In the experiments, the audio captured by this 360 degree multi-channel microphone was mixed together, amplified, and sent to headphones on the bad right ear simultaneously. Remarkably, Applicant's hearing, though now artificial, was virtually restored in this configuration including all cues necessary to locate sound sources in three-dimensional space.

Referring to FIGS. 24, 25, 26A and 26B, sensory nerves also give information as to where sounds come from in space. The auricle is innervated by contributions from both cranial and spinal nerves. They include the great auricular nerve (C2, C3), the auriculotemporal nerve (V3), the lesser occipital nerve (C2, C3), and a branch of the vagus nerve (X Arnold's nerve). The great auricular nerve divides into an anterior and posterior branch. The anterior branch supplies the lower half of the lateral aspect of the auricle. The posterior branch supplies a similar area on the medial surface of the auricle. The auriculotemporal nerve supplies the superolateral surface of the auricle. The lesser occipital nerve supplies the superior aspect of the ear on the medial side. The concha is supplied by Arnold's nerve.

Also, post-operatively, as a result of nerves being cut during the operation in the outer ear area, the SENSATION of the sound source moving front to back (that was discovered in the previous “moving earbud” experiments noted above), was also lost completely by Applicant. No sensation of sound was generated at all when touching these parts of the ear with a fingertip. Applicant concluded that the fact that there was not “sound” being generated at all anymore with fingertips—as it had been before by physical stimulation, it most probably meant that the sensory nerves located in the Helix and Tragus (as well as other part of the pinnae) are responsible for the SENSATION of sound when these parts of the ear are stimulated physically by touch. These nerves actually let a person FEEL sound in different locations in space. When there are no functioning nerves there, there is no “sound” generated. The sound of fingertips gently touching these separate parts of the ear on one side, simply cannot provide enough acoustic sound pressure level to the opposite ear for HRTF to work in both ears and be the sole source of three-dimensional location abilities. The sensation of the generated sound moving back and forth still exists on each single ear independently when the nerves are intact regardless of HRTF: hence movement in soundwaves of a moving sound source can be detected by the nervous system without acoustic energy being transmitted to the internal ear via soundwaves at all.

Referring to FIGS. 27 and 28, experiments were done which suggest that the same sensation of front to back audio achieved in one ear could be somewhat replicated by tapping on the bone in front of the ear at the top of the jawline (which presents itself to people as audio coming from the front). Alternatively, tapping the bone behind the ear with eyes closed presents itself as audio coming from the back on that same side. There is a definite connection between the nervous system and the feeling of sensation of audio movement in space that goes beyond the HRTF system. This extra-auditory, internal Neuro/Tactile sensory-localization system can be utilized in hearing impaired people when stimulated properly, to give back a sense of localization that has not been used until now in hearing assistive technology. It can make hearing impaired people experience life in three dimensions.

Utilizing U.S. Pat. No. 5,778,083, entitled, “GLOBAL SOUND MICROPHONE SYSTEM,” which had a publication date of Jul. 7, 1998, the output of multiple microphones that capture sound in multiple directions simultaneously and whose captured sound is amplified and played back to headphones at the same time, was employed in listening experiments. This greatly improved the ability of the wearer to locate a sound source's location in space, but a large, external device like that would be ungainly to use in actuality in the field for a hearing compromised person. It teaches though, that microphones placed around the perimeter of a device shaped predominantly like the human head will naturally direct the individual pickup pattern of microphones in an outward direction and away from the head. Utilizing the unique shape of the human head and its specialized physical structures in relation to hearing, we can utilize the head itself as a platform to pick up the sounds in a manner that is familiar to our brains. The present invention described below achieves this goal. For it to function optimally, the shape of the head is an important part, and the present invention similarly follows the lines of the face and head in its implementation of microphone capsule placement in order to achieve correct three-dimensional sound pickup and the desired effect of localization in three-dimensional space.

U.S. Pat. No. 6,980,661, entitled “Method of and apparatus for producing apparent multi-dimensional sound,” which had a publication date of Dec. 12, 2005 (and was filed Nov. 13, 2001 as U.S. application Ser. No. 09/987,217 with priority claim to U.S. Provisional Application No. 60/248,225 filed on Nov. 15, 2000) also teaches taking the signal from a multi-channel microphone and converting it via HRTF processor and volume control to a stereo output for two ears and two channels of binaural playback, Left and Right). This systems application could possibly be beneficial to utilize in directionally-compromised hearing-impaired people as an external audio capture system, but the playback system would be non-advantageous for people who have compromised inner ear functionality as it plays back audio on traditional stereo headphones so the audio output would be practically inaudible.

For a person with normal hearing there are two elements that are necessary for an audio capture system that can provide three-dimensional audio for one ear or Ideally, there should be multiple microphones picking up sound in three dimensions so that relative signal volumes can be picked up in their relative location in space and played back in the same corresponding space electronically. It can be as little as two microphones spaced coincidently on each ear area in a system where the wearer has good hearing in both ears. In order to play the sound back instantaneously to the listener in such a system, there must also be a speaker or transducer or headphone directed towards or into the ear, one for each ear. In a more accurate and perfected form of sound capture that enhances the 3-dimensional experience for the listener, multiple microphones placed coincidentally spaced around a listener's head in a configuration that can be utilized by processing to maximize the spatiality of a sound source and then feed this signal into a headphone, one for each ear, can be used.

When one or more of the listeners’ internal hearing systems are not functioning correctly (hearing-impaired), a different type of configuration must be utilized. It is for these purposes that this invention was created.

### SUMMARY

In one aspect a bone-conductive audio system includes at least one head-worn hearing enhancement apparatus. The head-worn hearing enhancement apparatus comprises at least one microphone in front of the outer ear generally picking up sound in a forward outward direction and at least one microphone behind the outer ear picking up sound in a more rearward outward direction. First and second amplified vibration transducers interact with the at least one microphone in front of the outer ear and the at least one microphone behind the outer ear. The first and second amplified vibration transducers are drawn toward audio conductive bones. Placement of the at least one microphone in front of the outer ear and the at least one microphone behind the outer ear feeds the naturally captured discrete audio signals, front and rear, captured in a physical location on the head to the first and second amplified vibration transducers to create organically recognizable audio spatiality.

In some embodiments the at least one head-worn hearing enhancement apparatus includes a first head-worn hearing enhancement apparatus adapted for positioning adjacent to the left ear of the user and a second head-worn hearing enhancement apparatus is adapted for positioning adjacent to the right ear of the user.

In some embodiments the first and second head-worn hearing enhancement apparatuses are connected via a resilient biased band that is shaped and dimensioned for positioning about the head of the user, wherein the resilient biased band draws the first and second head-worn hearing enhancement apparatuses toward each other such that the first and second amplified vibration transducers are drawn into contact with skin of the user in alignment with bone to which vibrations are transferred.

In some embodiments the second head-worn hearing enhancement apparatus is an approximate mirror image of the first head-worn hearing enhancement apparatus.

In some embodiments the first amplified vibration transducer is placed above the bone, superficial to the skin on the front of the ear such that the first amplified vibration transducer vibrates the area in front of the tragus and also vibrates on the front part of the temporal bone as well as simultaneously stimulating the tragus area nervous system. The second amplified vibration transducer is placed behind the ear simultaneously stimulating the rear portion of the mastoid bone and the tactile nervous system towards the rear of the ear.

In some embodiments the at least one head-worn hearing enhancement apparatus includes an over the ear mounting frame.

In some embodiments the over the ear mounting frame includes an arcuate central support member that is shaped and dimensioned for engagement between the helix of the ear and the area of the scalp adjacent the helix of the ear.

In some embodiments the arcuate central support member includes a first end adapted for positioning toward the front of the ear and a second end adapted for positioning toward the rear of the ear.

In some embodiments an anterior first housing member is coupled at the first end of the arcuate central support member and a posterior second housing member is coupled at the second end of the arcuate central support member.

In some embodiments the first amplified vibration transducer is mounted on the over the ear mounting frame within the anterior first housing member such that it is positioned at the front of the outer ear on the front portion of the temporal bone and touching the Tragus area of the outer ear, and the second amplified vibration transducer is mounted on the over the ear mounting frame within the posterior second housing member such that it is behind the outer ear on the rear portion of the temporal bone.

In some embodiments the at least one microphone includes an array of microphones placed on the perimeter of the over the ear mounting frame.

In some embodiments the array of microphones includes a first microphone mounted within the anterior first housing member such that the first microphone faces a predominantly forward direction and provides audio to the first amplified vibration transducer in the front of the ear and the array of microphones includes a second microphone mounted within the posterior second housing member such that the second microphone faces outward and away from the rear of the ear when the first head-worn hearing enhancement apparatus is in use and provides audio that is delivered to the second amplified vibration transducer in the rear of the ear.

In some embodiments the at least one microphone includes an array of microphones.

In some embodiments the at least one head-worn hearing enhancement apparatus includes a portable power source.

In some embodiments the power source is a rechargeable or replaceable battery.

In some embodiments the at least one microphone captures live audio information and simultaneously plays back incoming multi-channel and multi-directional audio information over the first amplified vibration transducer and the second amplified vibration transducer, respectively, along the front and rear portions adjacent the ear.

In some embodiments the at least one head-worn hearing enhancement apparatus includes a battery, electronics, processing, and controls.

In some embodiments magnets are integrated into the at least one head-worn hearing enhancement apparatuses such that they interact with subdermal bone-mounted magnets or metal plates to draw the at least one head-worn hearing enhancement apparatuses into contact with the skin of the user in alignment with the bone to which vibrations are transferred.

In another aspect a bone-conductive audio system includes at least one head-worn hearing enhancement apparatus comprising at least one microphone located near the outside of the ear generally picking up sound in an outward direction. The bone-conductive audio system also includes an audio splitter that multiplies the incoming audio signal derived from the at least one microphone into at least two signals creating a secondary audio signal. A first amplified vibration transducers interacts with the at least one microphone on the outer ear directly, the first and second amplified vibration transducers being drawn toward audio conductive bones; one in front of and one behind the outer ear. Placement of the at least one microphone outside of the outer ear feeds the naturally captured discrete audio signal to the front playback transducer and the secondary audio signal to the rear transducer, to create recognizable audio spatiality.

In some embodiments an audio processor delays the at least one secondary incoming audio signal by one to fifty milliseconds and send its time-delayed audio signal to the second vibration transducer to create recognizable spatial audio.

In some embodiments an audio processor increases the relative volume of audio frequencies between 1 kHz and 5 kHz of the at least one secondary incoming audio signal and sends its modified audio signal to the second vibration transducer to create a recognizable spatial audio.

In another aspect a bone-conductive audio system includes at least one head-worn hearing enhancement apparatus comprising at least one microphone located near the outside of the ear generally picking up sound in an outward direction. First and second amplified vibration transducers interact with the signal provided by at least one microphone on the outer ear and a secondary audio signal. The first and second amplified vibration transducers are drawn toward audio conductive bones, one in front of and one behind the outer ear. Placement of the at least one microphone outside of the outer ear feeds the naturally captured discrete audio signal to the front playback transducer and a secondary audio signal is supplied to the rear transducer.

Other features and advantages will be apparent to people of ordinary skill in the art from the following detailed description and the accompanying drawings.

### BRIEF DESCRIPTION OF DRAWINGS

Aspects of the present disclosure are illustrated by way of example and are not limited by the accompanying figures with like reference numbers indicating like elements.

FIG. 1 is a schematic of the present bone conductive system.

FIG. 2 is a schematic of a disclosed embodiment of the bone conductive system of the present invention.

FIG. 3 is a perspective view of a worn head-worn hearing enhancement apparatus in accordance with a disclosed embodiment.

FIG. 4 is a perspective view of the head-worn hearing enhancement apparatus shown in FIG. 2.

FIGS. 5 and 6 are a perspective views of the head-worn hearing enhancement apparatus shown in FIG. 3 from the opposite direction of that shown in FIG. 4.

FIGS. 7 and 8 show alternate embodiments for the head-worn hearing enhancement apparatus.

FIG. 9 is a perspective view of a head-worn hearing enhancement apparatus in accordance with an alternate embodiment.

FIG. 10 is a schematic of the circuitry employed by the head-worn hearing enhancement apparatus of FIG. 9.

FIGS. 11, 12, and 13 show various embodiments of bone conductive system in accordance with the present invention.

FIG. 14 is a perspective view of yet another embodiment of a bone conductive system in accordance with the present invention.

FIGS. 15 and 16 disclose additional embodiments of a bone conductive system in accordance with the present invention.

FIGS. 17 and 18 are a sectional view and a perspective view, respectively, showing another embodiment of the present bone conductive system.

FIGS. 19 to 28 show various anatomical views relating to the human auditory system, wherein FIG. 19 shows the ear and hearing mechanism, FIG. 20 shows how we as humans hear, FIG. 21 shows inter-aural time differences in localization of sound sources between two ears, FIG. 22 shows how sound enters the human ear,

FIG. 23 shows the structure of the outer ear, FIG. 24 shows the nerves of the human ear, FIG. 25 shows the human facial nerves, FIGS. 26A and 26B show the outer ear nerves (front and back), FIG. 27 shows the temporal bone location and its relation to the ear, and FIG. 28 shows the internal structure of the ear.

### DESCRIPTION OF THE PREFERRED EMBODIMENTS

As will be appreciated by one skilled in the art, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely in hardware, firmware, or in a combined software and hardware implementation that may all generally be referred to herein as a “circuit,” “module,” “component,” or “system.” Furthermore, aspects of the present disclosure may take the form of a computer program product embodied in one or more non-transitory computer readable media having computer readable program code embodied thereon.

Aspects of the present disclosure are described herein with reference to flowchart illustrations and/or block diagrams of methods, apparatuses (e.g., systems), and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of computing device, or other programmable data processing apparatus, such that the instructions, which execute via the processor of the computer device, cause the computing device to perform operations specified in the flowchart and/or block diagram blocks. A processor may control one or more devices and/or one or more sensors described herein.

These computer program instructions may also be stored in a non-transitory computer readable medium that, when executed, may direct a computer, other programmable data processing apparatus, or other devices to function in a particular manner, such that the instructions, when stored in the non-transitory computer readable medium, produce an article of manufacture comprising instructions which, when executed, cause a computer to implement the operations specified in the flowchart and/or block diagram blocks. The computer program instructions may also be loaded onto a computer, other programmable instruction execution apparatus, or other device to cause a series of operations to be performed on the computer, other programmable apparatuses, or other devices to produce a computer implemented process, such that the instructions which execute on the computer or other programmable apparatus provide processes for implementing the operations specified in the flowchart and/or block diagram blocks.

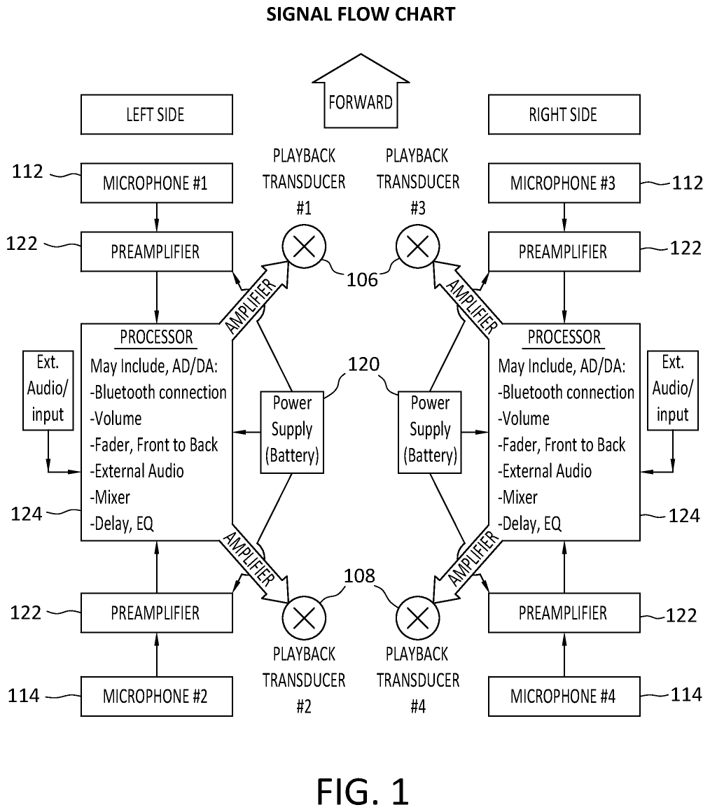

As discussed above, the present invention was developed to overcome the problems confronted by those dealing with human internal hearing systems that are not functioning correctly (hearing-impaired). While various embodiments are disclosed in accordance with the present invention, FIG. 1 is a schematic showing the functional elements underlying the present invention.

Referring to FIG. 1, as well as the other figures presented in accordance with this disclosure, a plurality of vibration or bone conductive amplified transducers 106, 108 are arranged, at least two per ear, one of the bone conductive amplified transducers 106 in front of the ear and one of the bone conductive amplified transducers 108 behind the ear. They can be of a type and may contain a magnet 150 that interacts with two subdermal metal plates 152 attached to the bone underneath (one in front and one behind the ear); or they can simply rest on the surface of the skin in those locations. These individual bone conductive amplified transducers 106, 108 receive the audio output from microphone array 111 located on both the left and right side of an individual's head, for example, composed of first and second microphones 112, 114 elements, generally containing the discrete audio information supplied by the same microphone in the same region as the bone conductive amplified transducers, for example, the front first microphone 112 signal is sent exclusively to the front first bone conductive amplified transducers 106 and the rear second microphone 114 will provide its signal exclusively to the rear second bone conductive amplified transducers 108.

Before being sent to either of the bone conductive amplified transducers 106, 108, the signal captured by the microphones 112, 114 is processed via the application of a preamplifier 122 and a signal processor 124. It is appreciated that signal processing is well known in the art and signal processing in accordance with the present invention may include, for example, analog to digital/digital to analog converters, volume controls, wireless connectivity (for example, Bluetooth), faders, mixers, delays, external audio introduction, etc. The entire system is preferably powered by batteries 120.

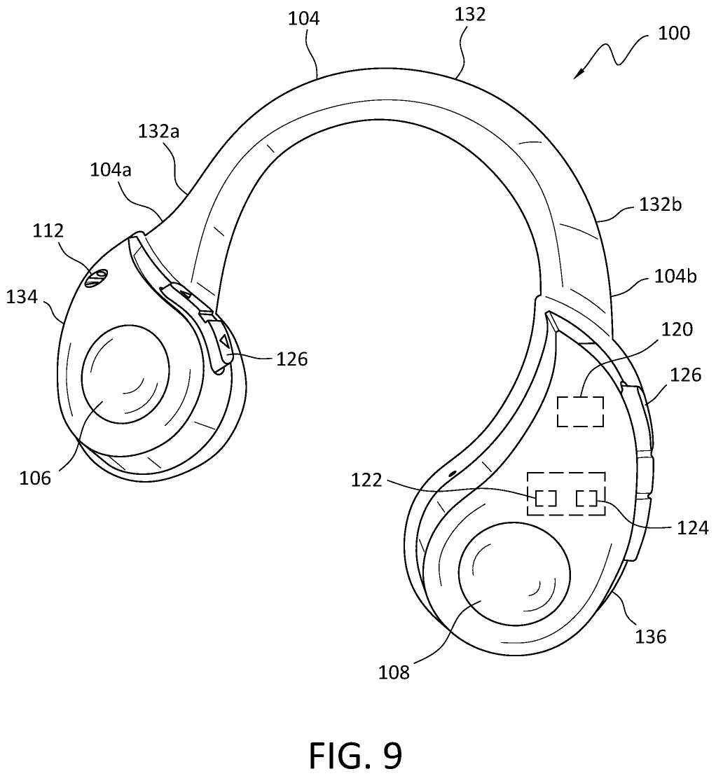

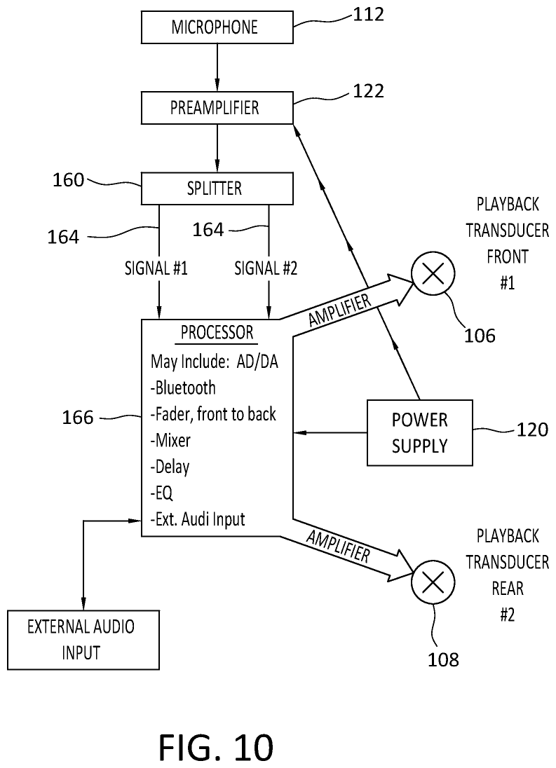

In a simpler embodiment of this system, and as discussed in detail below with reference to FIGS. 9 and 10, the system contains only one microphone element per ear and two playback transducers per ear, utilizing the single microphone element that is picking up sound in a direction facing away from the head in an outward and slightly forward direction can be used. The audio output of this individual microphone (per-ear) can be divided or split and sent to both front and rear playback transducers. After the division of the incoming signal, A processor including an audio delay in the signal of between 1 and 10 milliseconds may be applied to the signal sent to the rear playback transducer element to emulate the physical space located between the front area and the rear area of the human ear. Further audio processing such as room simulation or reverberation can also be supplied along with this signal to further enhance the effect of space. Additionally, audio equalization or signal manipulation can be applied to enhance the frequency of the incoming sound source so that 1-5 kHz is enhanced. This frequency directly correlates to the ability of the human brain to perceive localization and is also the predominant frequency of the human voice. This equalization can be applied to both channels of audio.

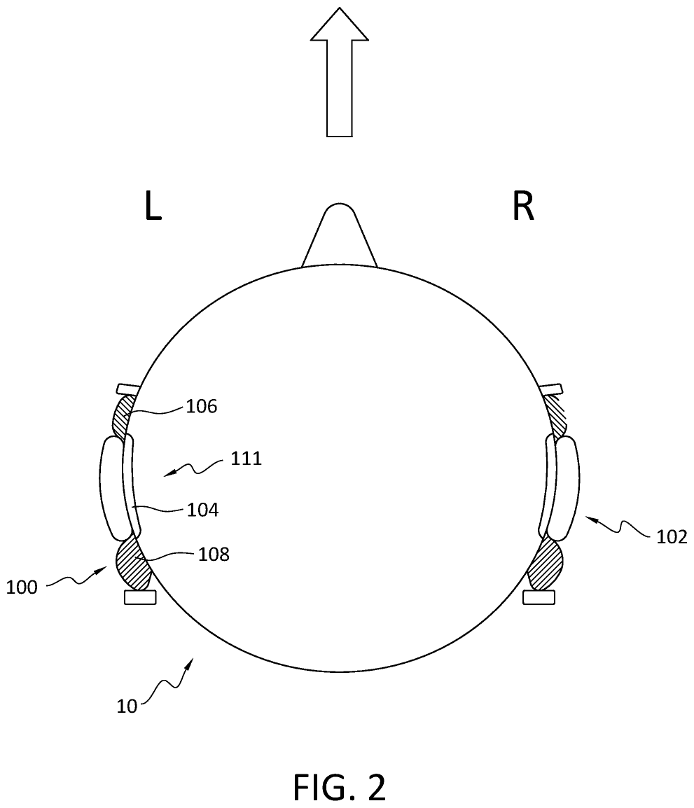

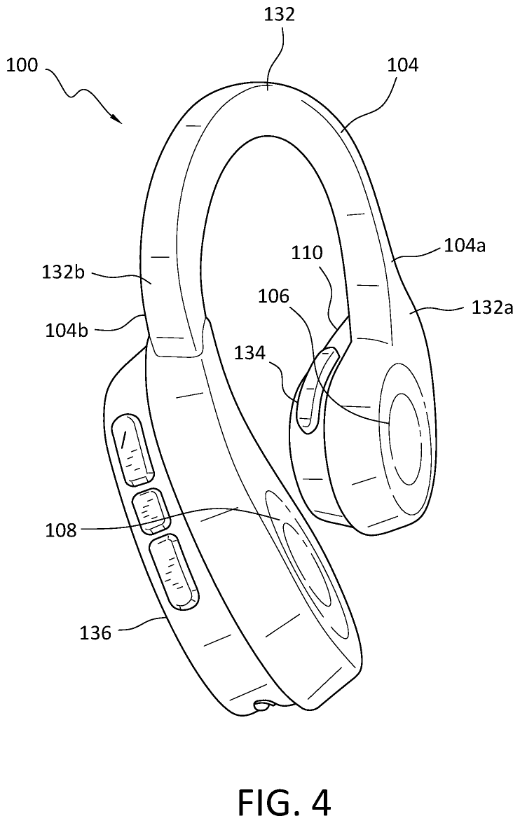

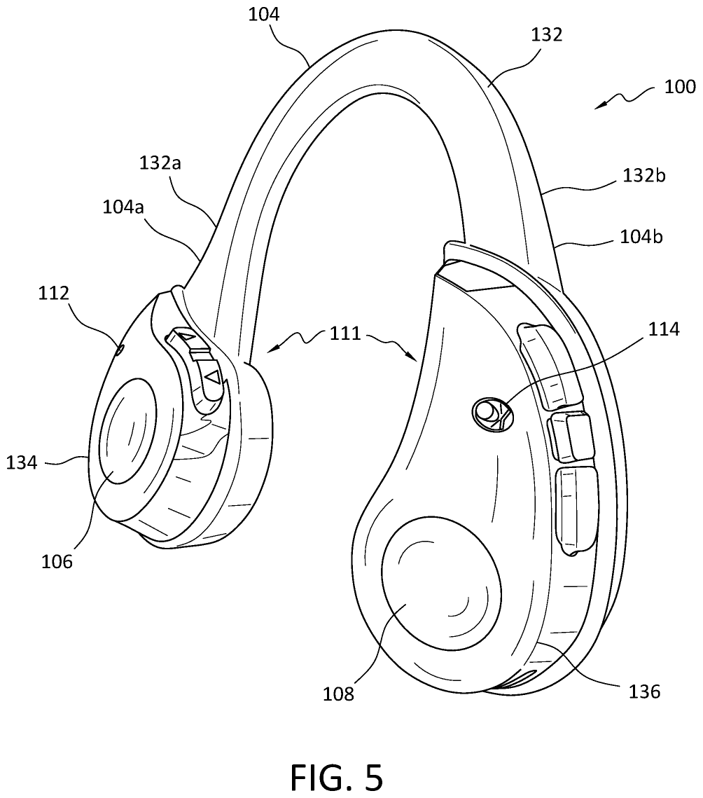

Referring to FIGS. 2 to 6, a bone-conductive audio system 10 is disclosed. While the present bone-conductive audio system 10 is described for use as a hearing aid for people with hearing loss, it is appreciated the concepts underlying the present audio system may be applied to other audio uses.

In lieu of proper function of the human acoustic hearing mechanisms, the bone-conductive audio system 10 is designed to work with the human body's other natural sensory abilities (such as touch and feeling, via the nervous system) as well as supplementing any hearing ability still available to the user. In order to compensate for the loss or non-existence of one of a person's major sensory abilities, a form of spatial hearing enhancement not previously available is provided by the present bone-conductive audio system 10 to help the many hearing-impaired people in the World get back some of their ability to function normally in everyday life. The bone-conductive audio system 10 is easily wearable, comfortable, effective, and affordable, and the bone-conductive audio system 10 will change many peoples' lives as well as enhancing hearing abilities and elevating the experience of the lives of those with normal hearing too, by providing the ability of the wearer to locate sound sources, either captured live in the environment or by audio media delivered to the device via Bluetooth from a phone, etc.. by providing this sound to the listener naturally, cohesively and in three dimensions, this will allow them to enjoy a more normal, safe, and fulfilling life.

As will be appreciated based upon the following disclosure, the bone-conductive audio system 10 employs a multi-channel microphone hearing augmentation system, a multi-channel bone-conductive and neurally-stimulating sound transducer system, a multi-directional microphone pickup pattern or audio derived from a single channel that is modified to provide a multi-channel output via splitting and processing of the audio information captured for hearing enhancement, and a head-worn enhanced hearing system that provides for neurally conductive spatial hearing. The bone-conductive audio system 10 enhances directional/spatial hearing abilities for those who are hearing impaired. For normal-hearing people, as well as for those with hearing loss, the bone-conductive audio system 10 provides true practical multi-channel surround sound delivery via multi-channel bone conductive headphones.

In accordance with a disclosed embodiment, each head-worn hearing enhancement apparatus 100, 102 of the bone-conductive audio system 10 contains two microphones 112, 114 for each ear—at least one microphone 112 in front of the outer ear generally picking up sound in a forward direction and may contain at least one microphone 114 behind the outer ear picking up sound in a more rearward direction. Although the disclosed embodiments are specifically adapted for capturing ambient sounds, various wireless technologies (e.g., Bluetooth) may be used to connect each of the head-worn hearing enhancement apparatuses 100, 102 to a smartphone or tablet for music, multimedia, etc. As a result, the bone-conductive audio system 10 works automatically to provide excellent spatial multichannel surround sound from pre-recorded or broadcast media—such as a movie file on their phone that includes multichannel audio information—as most movie files do.

As will be appreciated based upon the following disclosure, the bone-conductive audio system 10 relies upon the interaction between a plurality of specifically placed amplified vibration transducers 106, 108 and the plurality of specifically placed microphones 112, 114 (one in front and one behind the outer ear) that interact specifically with the amplified vibration transducers 106, 108. The placement of the microphones 112, 114 feeds the naturally captured discrete audio signals, front and rear, created in a physical location on the head. The playback of the naturally captured discrete audio signals makes sense spatially to the wearer of the device. In accordance with a disclosed embodiment, the playback of the captured signals is done discretely (or blended with the other captured signals as an option—but not necessary) with the captured signals being assigned to a specific playback transducer located in the same general physical area on the head as the microphone. This creates organically recognizable audio spatiality which does not require a computer or special processor to create an effect. It is physics and physiology that is at work here.

A first head-worn hearing enhancement apparatus 100 is adapted for positioning adjacent to the left ear of the user and a second head-worn hearing enhancement apparatus 102 is adapted for positioning adjacent to the right ear of the user. The second head-worn hearing enhancement apparatus 102 is a mirror image of the first head-worn hearing enhancement apparatus 100 and only the first head-worn hearing enhancement apparatus 100 is therefore disclosed herein in detail. The head-worn hearing enhancement apparatuses 100, 102 improve three-dimensional audio source localization for hearing enhancement, and for the restoration of directional hearing abilities in hearing impaired or partially hearing-impaired listeners.

As will be appreciated based upon the following detailed disclosure, the internal audio playback system of the bone-conductive audio system 10 relies upon amplified vibration transducers 106, 108 forming part of the head-worn hearing enhancement apparatuses 100, 102. The first amplified vibration transducer 106 corresponds to Channel 1 (front audio) and the second amplified vibration transducer 108 corresponds to Channel 2 (rear audio). The amplified vibration transducers 106, 108 are placed above the bone, superficial to the skin on the front of the ear. The front first amplified vibration transducer 106 vibrates the area in front of the tragus and also vibrates on the front part of the temporal bone as well as simultaneously stimulating the tragus area nervous system. Simultaneously, and with regard to the Channel 2 (rear audio), one or more amplified vibration transducers 108 are placed behind the ear (channel 2, rear) simultaneously stimulating the rear portion of the mastoid bone and the tactile nervous system behind the ear as noted in the drawings and as discussed below in more detail.

The amplified vibration transducers 106, 108 that surround the outer ear are fed audio information electronically that corresponds with their position in space Front or Back, Left or Right (when two paired devices are worn, one on each ear) based upon simultaneously captured audio via external microphones that are connected to the total system on the same frame.

When using paired devices (one on each ear simultaneously) 4 channels of discrete microphone sound capture, (two on each side of the face—Front Right, Rear Right, Front Left, and Rear Left) will correspond with 4 channels of discrete playback on transducers (2 on each ear) placed in the same configuration as the microphones noted above and relating electronically to the configuration that matches the pickup pattern of the microphones in space (Front Right, Rear Right, Front Left, and Rear Left).

In accordance with a disclosed embodiment, the following is believed to provide the best outcome for those with impaired hearing functionality. One or more amplified vibration transducers corresponding to Channel 1 (front playback audio) are placed closest to the area above the bone, superficially touching the skin on the front of the ear. The front transducer vibrates the area in front of the skin of the tragus and also vibrates on the front part of the temporal bone simultaneously. Additionally, and simultaneously, one or more amplified vibration transducers corresponding to Channel 2 (rear audio) are placed behind the ear which corresponds to Channel 2 (rear) as noted in the drawings.

The first head-worn hearing enhancement apparatus 100 includes an over the ear mounting frame 104 worn next to the skin and a plurality of amplified vibration transducers 106, 108. The over the ear mounting frame 104 includes an arcuate central support member 132 that is shaped and dimensioned for engagement between the helix of the ear and the area of the scalp adjacent the helix of the ear. The arcuate central support member 132 includes a first end 132a adapted for positioning toward the front of the ear (anteriorly) and the second end 132b adapted for positioning toward the rear of the ear (posteriorly).

As those skilled in the art will appreciate, bone conduction transducers are known in the art and various types may be used in accordance with the present invention. Briefly, bone conduction transducers turn sound into vibrations, conducting vibrations through the bones of the skull to the inner ear where they are detected and perceived as sound.

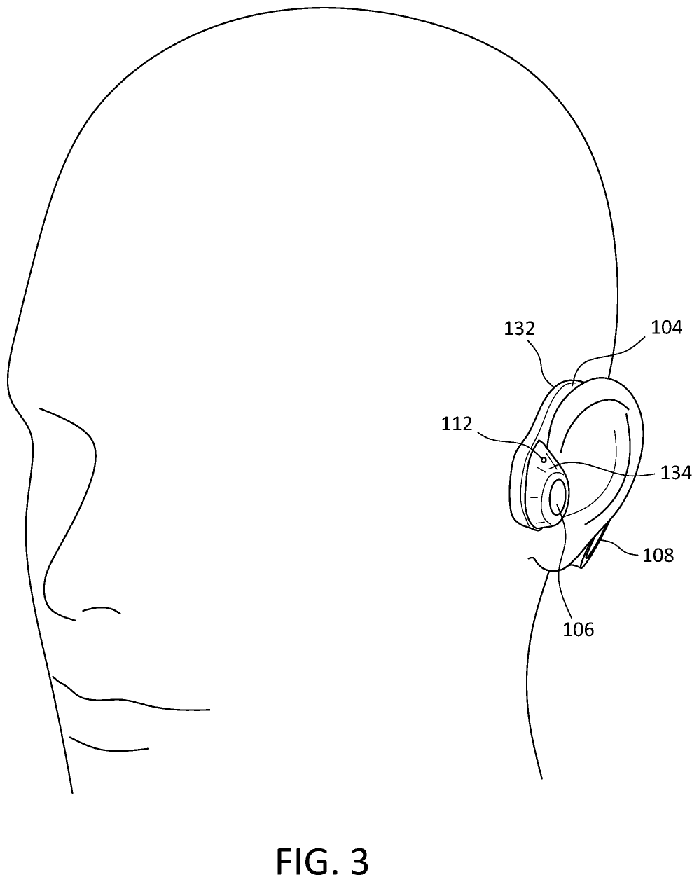

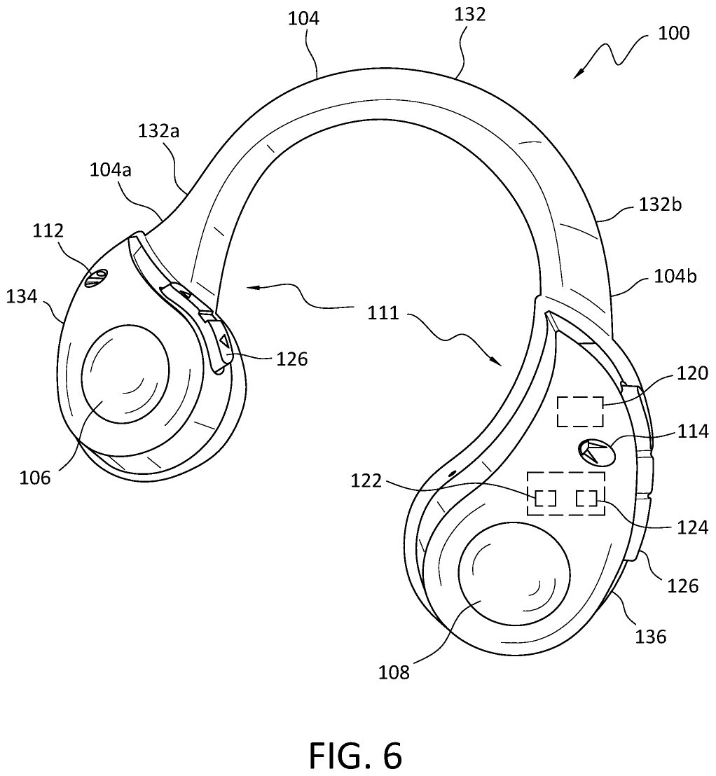

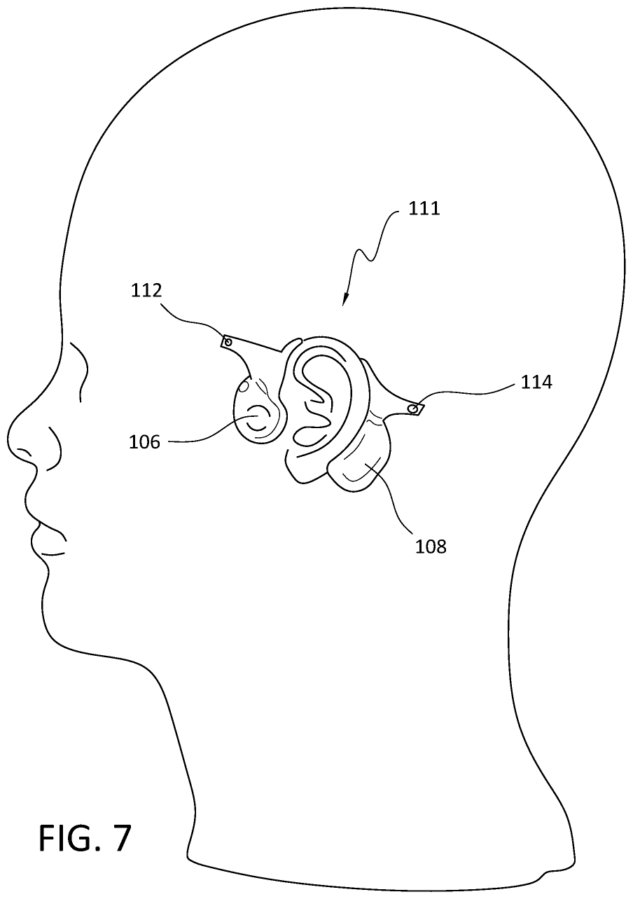

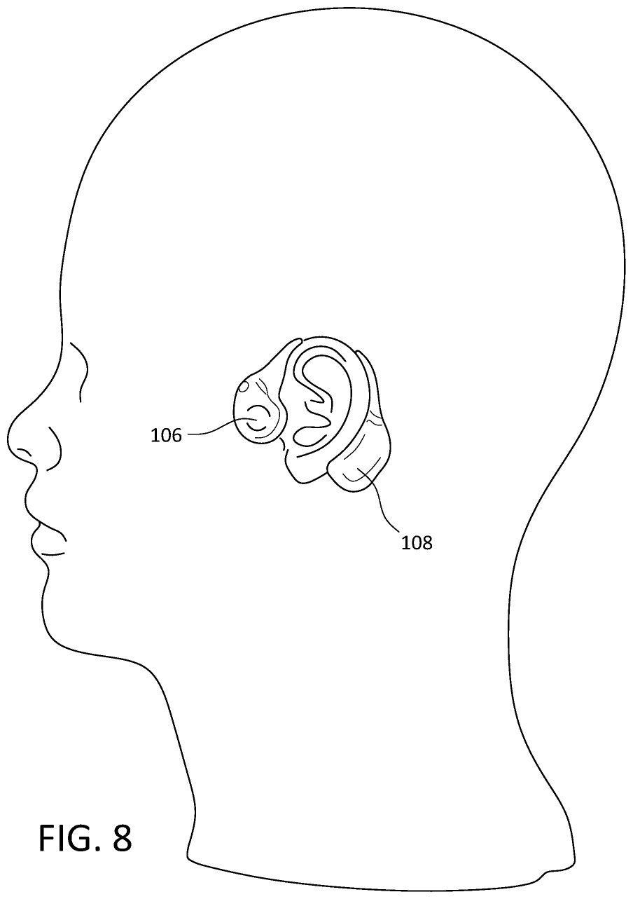

An anterior first housing member 134 is coupled at the first end 132a of the arcuate central support member 132 and a posterior second housing member 136 is coupled at the second end 132b of the arcuate central support member 132. While a housing of a specific shape is disclosed with reference to FIGS. 3 to 5, other shapes and designs may be used (for example, see FIGS. 6 and 7).

In accordance with a disclosed embodiment, at least one of the plurality of amplified vibration transducers (a first amplified vibration transducer 106) is mounted on the over the ear mounting frame 104 within the anterior first housing member 134 such that it is positioned at the front of the outer ear, preferably on the front portion of the temporal bone and touching the Tragus area of the outer ear. At least one of the plurality of amplified vibration transducers (a second amplified vibration transducer 108) is mounted on the over the ear mounting frame 104 within the posterior second housing member 136 such that it is behind the outer ear, preferably on the rear portion of the temporal bone.

It is advantageous that the over the ear mounting frame 104 has a support structure 130 nearest the rear second amplified vibration transducer 108 that physically contacts the proximate area of the helix portion of the outer ear when the over the ear mounting frame 104 is positioned for use. Each of the first amplified vibration transducer 106 and the second amplified vibration transducer 108 delivers one discreet channel of audio per transducer, derived from a multi-channel sound source 110 (discussed below), and plays back the audio via at least two channels, front and rear.

In accordance with a disclosed embodiment, the first head-worn hearing enhancement apparatus 100 is open to the air, although it is appreciated the head-worn hearing enhancement apparatus could be provided with an enclosure structure (for example, a cup) that covers the ears that is part of a set of over the ear headphones. It is appreciated that although a left first head-worn hearing enhancement apparatus 100 and a right first head-worn hearing enhancement apparatus 102 are disclosed herein, a single head-worn hearing enhancement apparatus can be worn over one ear.

Additionally, and to add increased functionality to the first head-worn hearing enhancement apparatus 100, an array of microphones 111 is placed on the perimeter of the over the ear mounting frame 104 that is worn on the head and placed flat against the skin. At least one microphone of the array of microphones 111 (a first microphone 112) is mounted within the anterior first housing member 134. As such, the first microphone 112 faces a predominantly forward and outward direction when the first head—worn hearing enhancement apparatus 100 is in use and provides audio to the first amplified vibration transducer 106 in the front of the ear. At least one microphone of the array of microphones 111 (a second microphone 114) is mounted within the posterior second housing member 136. As such, the second microphone 114 faces predominantly outward from the rear of the head when the first head—worn hearing enhancement apparatus 100 is in use and provides audio that is delivered to the second amplified vibration transducer 108 in the rear of the ear. The microphones 112, 114 pick up sound discretely that is played back simultaneously.

More specifically, the ear mounting frame 104 ideally has a form factor adapted for mounting such that it surrounds the ear, and the anterior first housing member 134 or the posterior second housing member 136, for individual discreet audio capture via at least two discretely located microphones 112, 114; the first microphone 112 resides in a mounting of the frame portion 104a that faces generally forward to the front of the face and located in front of the ear and the rear second microphone 114 resides in a mounting of the frame portion 104b facing generally to the rear and located behind the ear. The second microphone 114 is mounted behind the outer ear area but not directly underneath the pinnae unless the pickup pattern of the second microphone 114 is directed away and to the rear of that obstruction. Mounting of the first and second microphones 112, 114 must be done to isolate the pickup pattern of each of the first and second microphones 112, 114 individually either electronically or via a mounting or baffle system so as to avoid handling noise and acoustic feedback (from the effect of a transducer and microphone that is in such close proximity to each other).

While a disclosed embodiment shows first and second amplified vibration transducers and first and second microphones, it is appreciated additional transducers and microphones could be employed without departing from the spirit of the present invention.

It is also appreciated that although multiple microphones are used in the embodiment disclosed above, a single microphone system is possible with the application of signal processing to account for the creation of a full sound and the perception of directionality of the source sound. In particular, and with reference to FIG. 9, the head—worn hearing enhancement apparatus 100 is substantially the same as disclosed above, but includes a single microphone 112, preferably mounted toward the front of the head—worn hearing enhancement apparatus 100 nearest the mouth. Referring to FIG. 9, the microphone 112 is connected to an audio splitter 160 (of the processor 124) that multiplies the incoming audio signal, that is, naturally captured discrete audio signals, derived from the microphone 112 into at least two signals creating a first audio signal 162 and a second audio signal 164.

The first and second audio signals 162, 164 generated by the incoming audio signal are then transmitted to the first and second amplified vibration transducers 106, 108, which, as with the embodiment disclosed above, are drawn toward audio conductive bones, and the first and second amplified vibration transducers 106, 108 vibrate such that the first audio signal 162 of the naturally captured discrete audio signal is reproduced by the first amplified vibration transducer 106 and the second audio signal 164 of the of the naturally captured discrete audio signals is reproduced by the second amplified vibration transducer 108 to create recognizable audio spatiality.

Prior to being transmitted to the first and second amplified vibration transducers 106, 108, the first audio signal 162 and the second audio signal 164 may be processed in a highly specific manner. After splitting the incoming audio signal, the first and second audio signals 162, 164 are processed by an audio processor 166. For example, the second audio signal 164 is subjected to an audio processor 166 that delays the second audio signal 164 by one to fifty milliseconds. The audio processor 166 also isolates specific frequencies of sound within the first and second audio signals 162, 164, and then either cuts or boosts the amplification of the various isolated frequencies (that is, frequency equalization); for example, increase the relative volume of audio frequencies between 1 kHz and 5 kHz. It is appreciated that the human hearing range is approximately 20 Hz to 2 kHz, but humans are naturally more aware of sounds in the range 3.5 kHz to 4 kHz and the present system considers this when adjusting volumes of sounds in specific frequency ranges. The audio processor 166 performs this isolation and volume adjustment. After the signals are fully processed, they are sent to first and second amplified vibration transducers 106, 108 to create recognizable spatial audio.

Through the application of the audio processing described above, the single microphone 112 is able to capture an audio source signal on the head, in particular, near the ear, and split the audio source signal for application to the two properly placed first and second amplified vibration transducers 106, 108. This produces an automatic improvement to the perceived sound quality for any listener with either normal or impaired hearing. This is due to having two specific areas of the nervous system and head bones stimulated simultaneously via two physical areas of amplification. Through this playback system that we know now to contribute to the brain's perception of spatiality. Additionally, louder is always “better” in hearing perception tests and this will—in its simplest form—provide a very robust audio delivery. This dual zone spatial effect will be an improvement immediately to any listener. While a one microphone embodiment, whose signal is equally or variably split and that feeds two amplified vibration transducers—even with no additional processing (delay, EQ)—will improve the listening experience and real world spatial perception especially for those with normal hearing. It is anticipated the spatial perception will not improve as much for hearing impaired listeners in this situation, though the additional volume will sound “better” to them as well.

As to the audio processing discussed above, that is, the delay and frequency equalization, Applicant has found improved spatial perception by delaying a signal captured at the microphone (oriented slightly forward on the head) slightly when sending this captured signal from the front to the back by between 6-10 milliseconds. This takes into account the time it takes for the signal to naturally travel that physical distance in space around a human skull. This slight delay does some trickery to the brain to make things sound more spatial. Applicant has also found that by frequency equalizing the signal, in particular, by enhancing sounds in the frequency range of 1 kHz to 5 kHz (i.e., the frequencies that our brain uses to locate sound sources in space) the spatial effect of the audio is improved.

It should, however, be noted that although the modification of the captured signal will sound more pleasing and spatial to listeners, both hearing impaired and normal hearing, the effect would be spatial but not as perceptually accurate as using two microphones as discussed in the preceding embodiment. The normal hearing person wouldn't notice the difference between one and two microphones as much (except that it would still sound “cool” or “better”), but the hearing impaired person may not experience the same perception of audio localization when using this only one microphone method.

It should further be appreciated that neither the delay and/nor frequency equalization are crucial to the operation of the present invention. However, it is appreciated delay and/or frequency equalization would provide beneficial results to anyone person who used the present system. The effect will definitely be more pronounced when both effects are applied together but using each effect separately will add an additional layer to the total effect.

Although the disclosed bone-conductive audio system 10 could be powered via wires for electricity, as well as for audio transmission when used in certain environments, ideally it contains a portable power source 116 (rechargeable or replaceable battery) so as to be an autonomous system. The portable power source 116 is housed in the anterior first housing member 134 or the posterior second housing member 136, although it is disclosed herein that the portable power source 120 is mounted in the posterior second housing member 136. This gives freedom of movement to the wearer while enhancing the ability to hear environmental sound in its precise location in three-dimensional space. The over the ear mounting frame 104 is shaped and dimensioned to wrap around the wearer's ear. Alternatively, in another embodiment of the invention as discussed below in more detail, the two head—worn hearing enhancement apparatuses may be connected via a mechanical frame around the face or top or rear of the head of a user. When paired together, both head—worn hearing enhancement apparatuses combine to form a single binaural system, for immersive hearing enhancement of both ears.

When audio is captured by the bone-conductive audio system 10, the microphones 112, 114 in their predetermined locations simultaneously play back the acquired live multi-channel and multi-directional audio information over the first amplified vibration transducer 106 and the second amplified vibration transducer 108, respectively, along the front and rear portions adjacent the ear. Audio derived from the associated area in space that it was originally captured is now stimulating both the bones and the nervous system in the region of the amplified vibration transducer 106, 108 on that same region on the surface of head. It is appreciated that the size of user's heads may vary and the bone-conductive audio system 10 can be made in multiple sizes or can be adjustable to suit users of differing sizes. The audio is predominantly bypassing the acoustic portion of the ears and its associated hearing apparatus and stimulating the other senses that also function to give awareness and localization in space. That there are at least two individual channels of spatially-derived audio being delivered to the user, one to the front and one to the rear, simultaneously, gives an unprecedented immersive experience in a very natural manner.

The bone-conductive audio system 10 is configured to function properly in a form that, when worn by a person on either side of the head, frames the outer ear. As mentioned above, the bone-conductive audio system 10 can be used for single ear applications to be worn autonomously.

Additionally, it can also be paired via wires or wirelessly to form a two-ear multi-channel unit that works when wearing two head-worn hearing enhanced apparatuses for both ears simultaneously that provides binaural hearing enhancement.

Also included within the ear mounting frame 104, and housed within either the anterior first housing member 134 or the posterior second housing member 136, are a battery 120, electronics (for example, a preamplifier) 122, processing 124, and controls 126. The battery 120, electronics 122, processing 124, and controls used in accordance with the present invention are based upon known technologies and various such technologies may be implemented without departing from the spirit of the present invention. Additionally, included within the ear mounting frame 104 are the individual playback first and second amplified vibration transducers 106, 108 that are respectively mounted within the anterior first housing member 134 or the posterior second housing member 136 that correspond to preassigned directions in three-dimensional space; generally, front and rear for both the left first head-worn hearing enhancement apparatus 100 and the right second head-worn hearing enhancement apparatus 102. The outputs of microphones 112, 114 are combined to deliver all the audio to the first and second amplified vibration transducers 106, 108 in a manner replicating the directionality of the ambient three-dimensional sound.

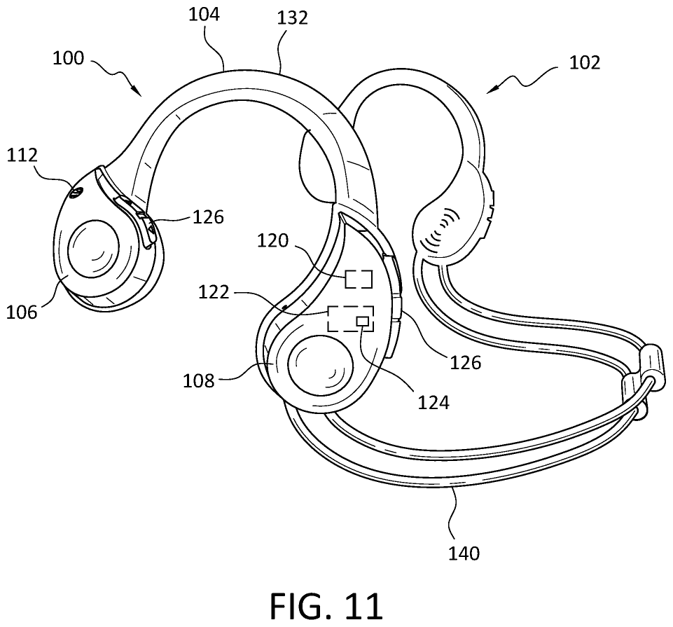

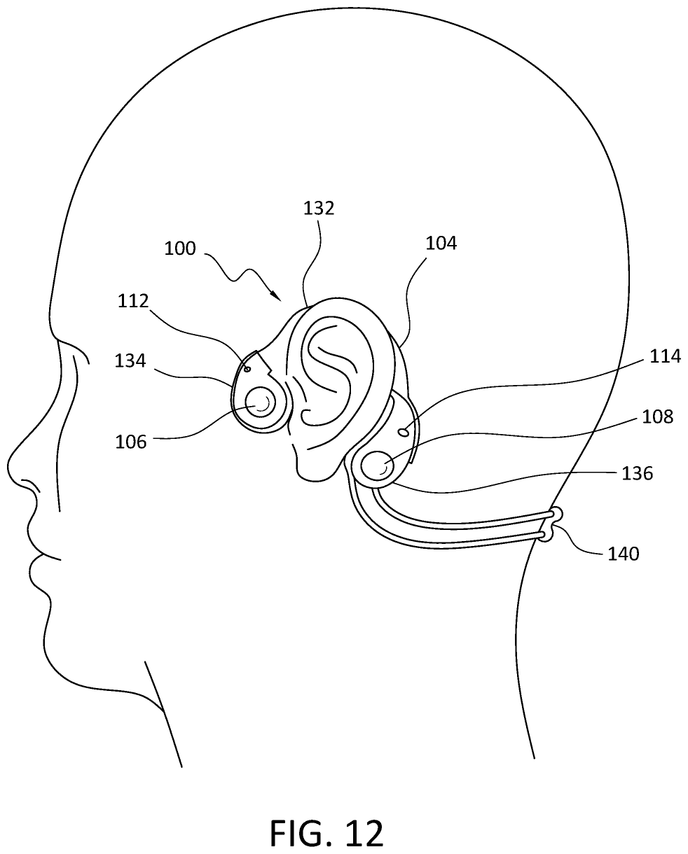

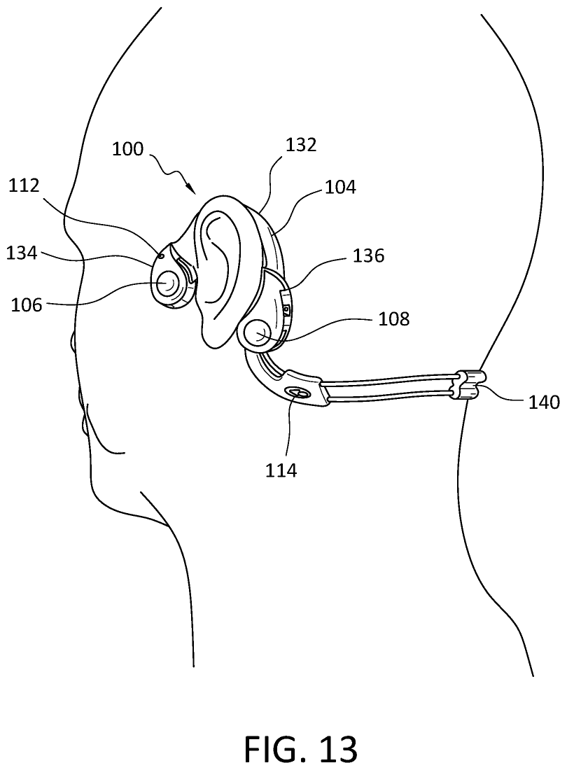

The embodiment disclosed above with reference to FIGS. 2 to 6 utilizes distinct first and second head-worn hearing enhancement apparatuses 100, 102, although other constructions for the mounting the vibration transducers adjacent the skin are appreciated. For example, and with reference to FIGS. 11 to 13, the first and second head-worn hearing enhancement apparatuses 100, 102 are connected via a resilient biased band 140 that is shaped and dimensioned for position about the head of the user. The resilient biased band 140 draws the first and second head-worn hearing enhancement apparatuses 100, 102 toward each other such that the amplified vibration transducers 106, 108 are drawn into contact with the skin of the user in alignment with the bone to which vibrations are transferred. FIGS. 11, 12, and 13 respectively show embodiments with a single microphone, a dual microphone, and a dual microphone with the second microphone on the band 140. It should be appreciated that the various embodiments utilize similar reference numerals for similar elements.

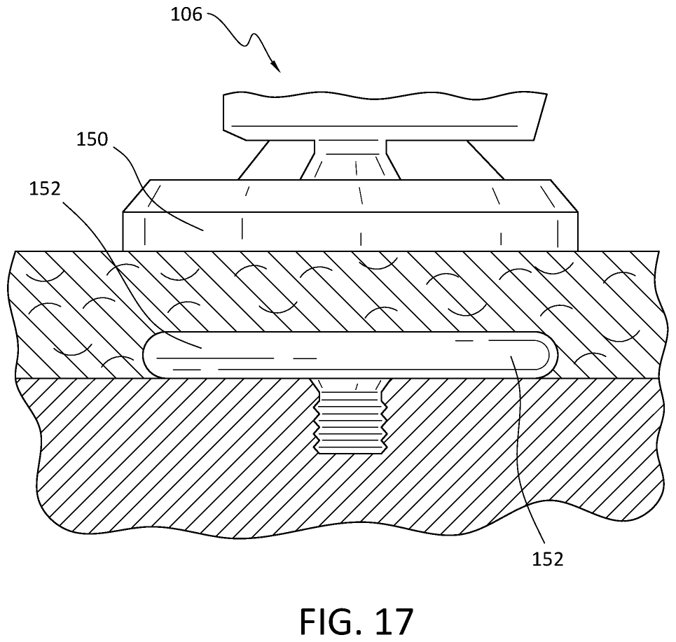

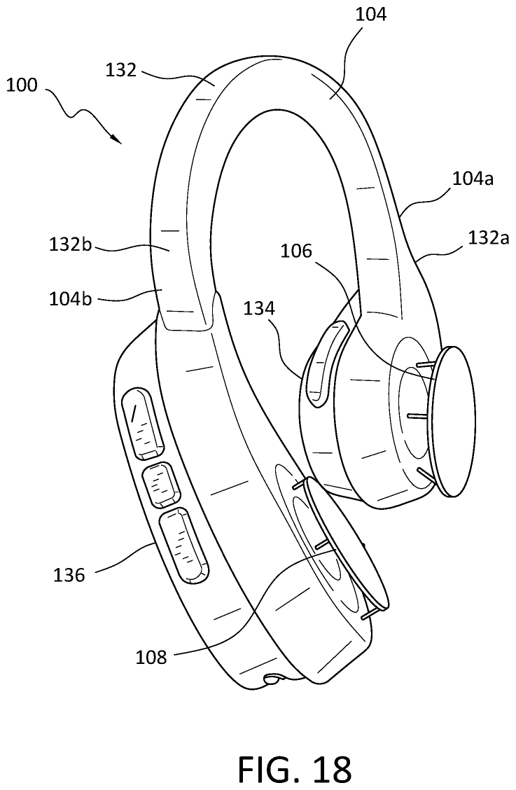

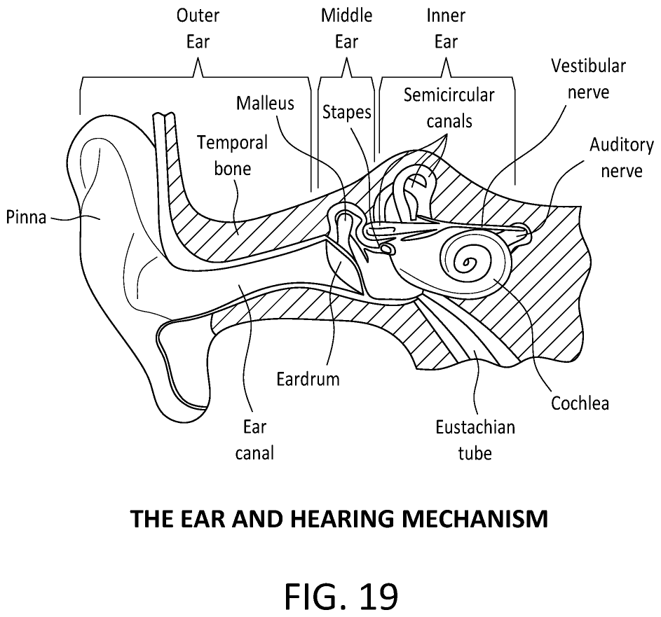

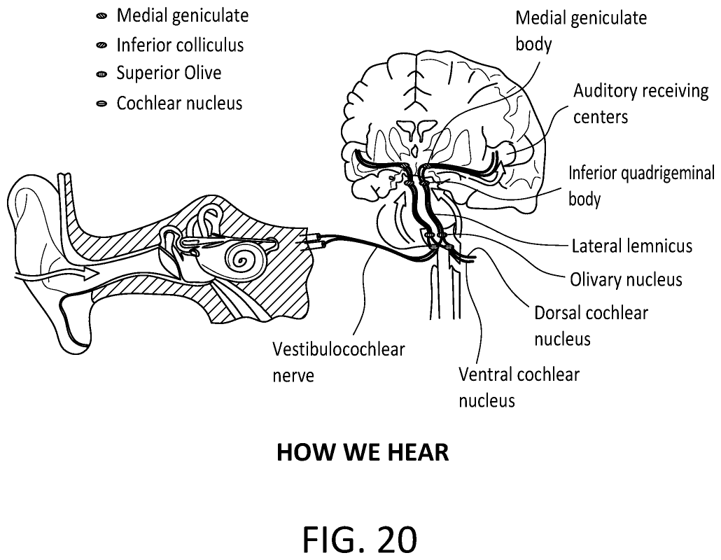

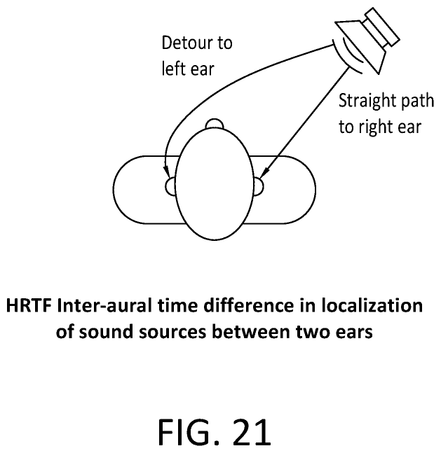

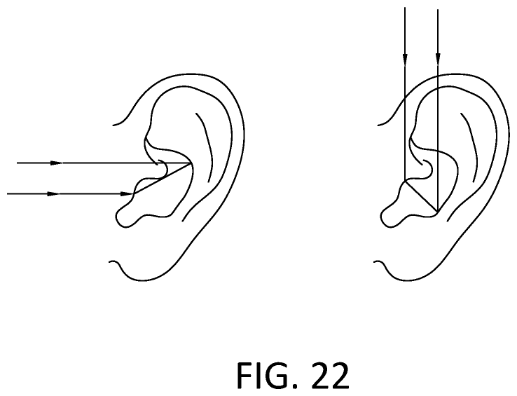

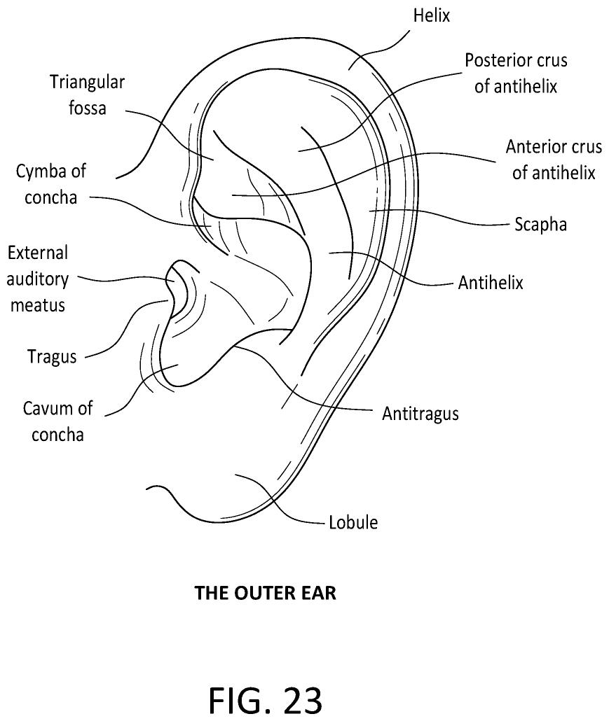

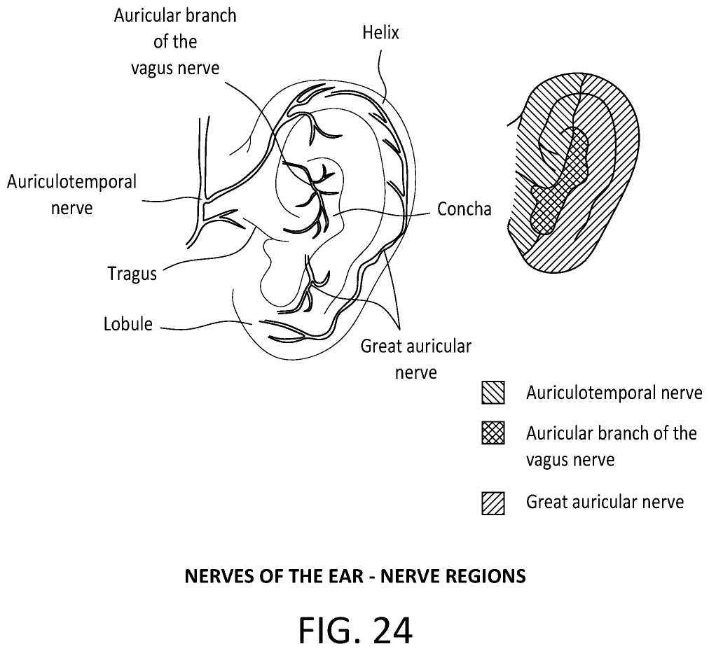

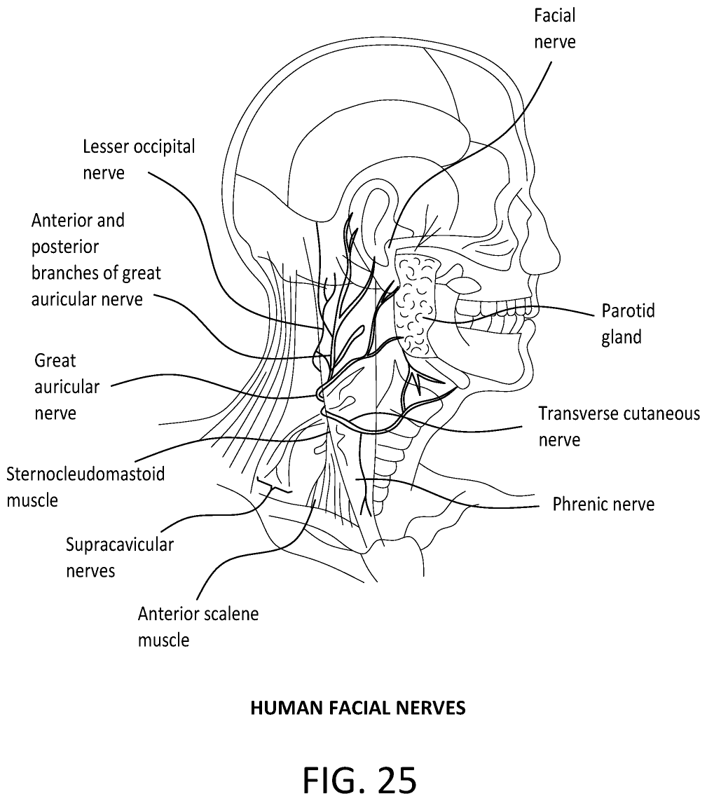

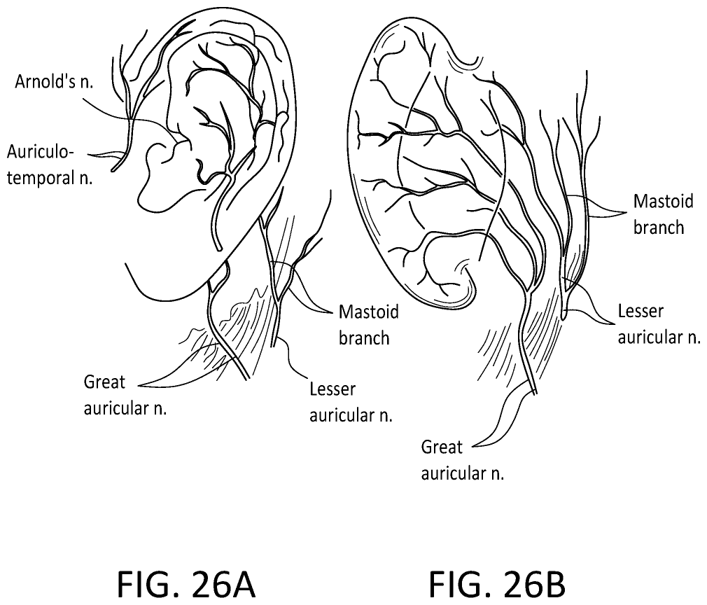

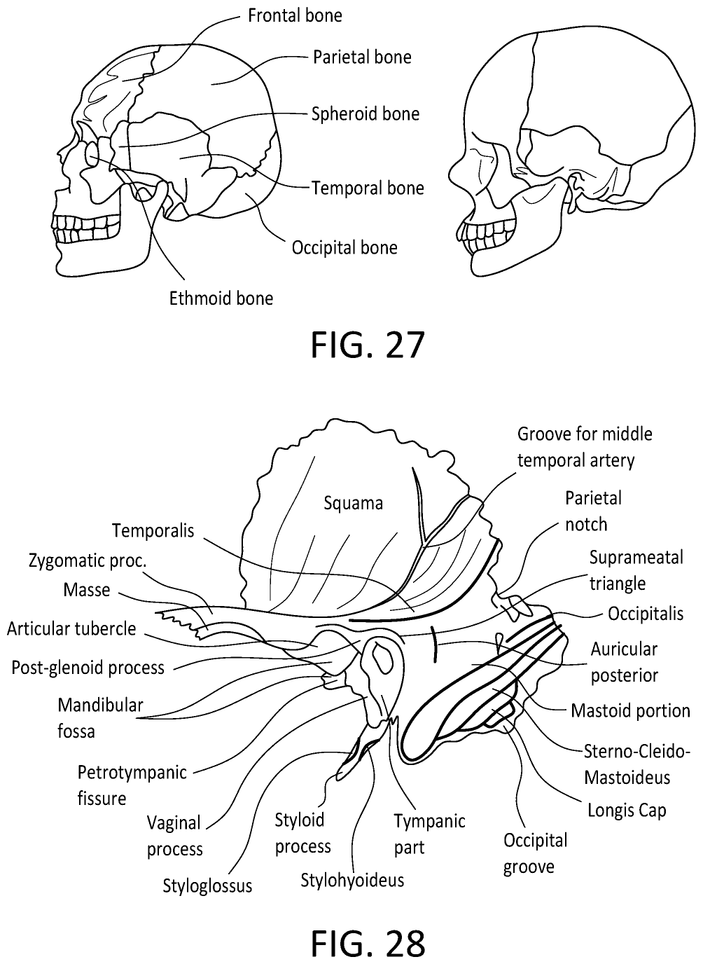

In accordance with another embodiment as shown with reference to FIGS. 17 and 18, magnets 150 are integrated into the first and second head-worn hearing enhancement apparatuses 100, 102 such that they interact with subdermal bone-mounted magnets or metal plates 152 to draw the first and second head-worn hearing enhancement apparatuses 100, 102 into contact with the skin of the user in alignment with the bone to which vibrations are transferred. For example, magnetic-type amplified vibration transducers 106, 108 that interact with under-the-skin or subcutaneous magnetic receivers 152 are provided and improve audio transmission in at least two areas of the skull improving the perceived direction of incoming signals—as well as the magnets helping to hold the device in place.

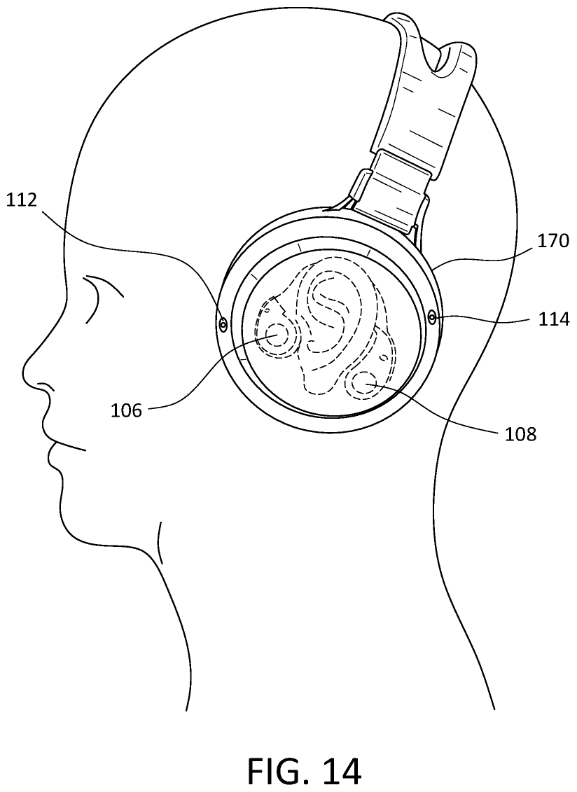

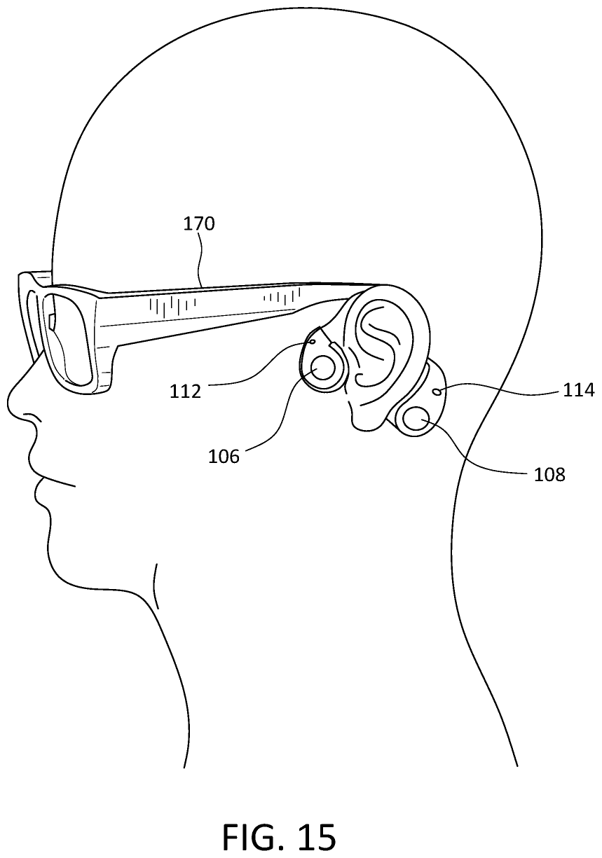

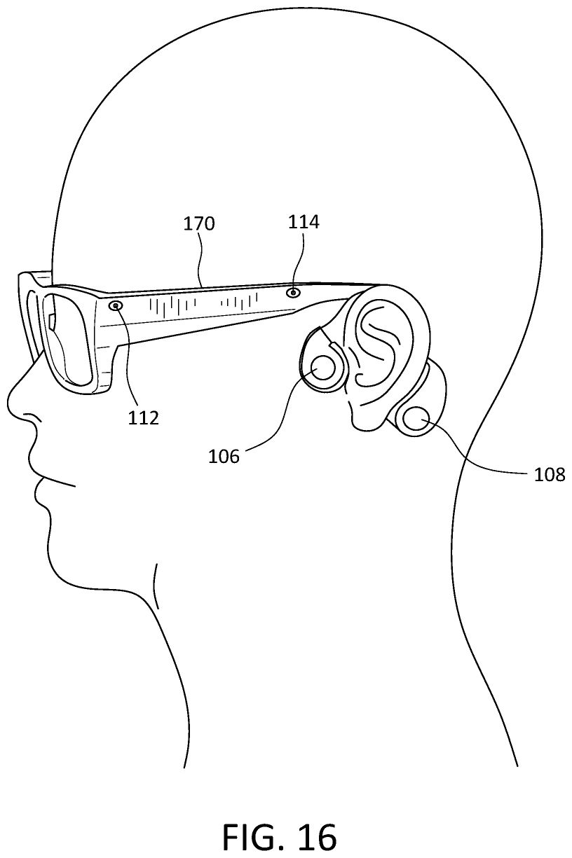

Further mounting structures are disclosed with reference to FIGS. 14 to 16, wherein amplified vibration transducers 106, 108 are integrated with microphones 112, 114 with supporting structures 170 (for example, an over-the-ear structure as shown in FIG. 14 and eyeglass frame supported structure as shown in FIGS. 15 and 16) maintaining the amplified vibration transducers 106, 108 in contact with bones as discussed above with regard to other embodiments.

Microphone capsules (or other sensors or transducers that detect audio waves and turn them into electrical signals) are individually mounted in a disclosed embodiment in an approximately equidistant manner at predetermined locations that correspond with the wearer's perspective of space in an outward facing direction. These directions in this embodiment of the invention would include:
1. Center or straight ahead, of the face,
2. Right Front of the face,
3. Left Front of the face,
4. Right Rear of the head and
5. Left Rear of the head (and behind the center of the head if possible),

and whose electronic audio pickup pattern faces outward in those directions correspondingly. The outputs of the microphones are then combined and processed simultaneously via an internal processing system located inside the apparatus that offers a control system that is simple for the user to operate.

Additional connectivity via Bluetooth or other wireless mechanisms could enable control via an application on a mobile phone which controls more advanced features including those associated with the tailoring of the bone-conductive audio system 10 specifically for the user's individual needs as in a hearing aid system or in order to compensate for specific frequencies and other hearing loss characteristics. Control of the bone-conductive audio system 10, such as the directivity (such as audio level or left/right and front/back balance), audio signal level limiting, frequency equalization, and spatial audio/HRTF (head related transfer function) processing may be implemented so that the combined output can be output into two channels and played back to the wearer.

In accordance with the embodiment disclosed herein, one amplified vibration transducer set (that is, the first and second amplified vibration transducers 106, 108) is provided for each ear and each set is assigned to a Left and Right output channel derived from the array of microphones 111 and the corresponding post-processing described herein. The bone-conductive audio system provides the wearer with a mechanism to hear sounds captured as they happen live, in three dimensions, and will make the bone-conductive audio system configurable by the user to enhance different directions of the perceived soundscape, in whole or in part, in order to compensate for the user's loss of hearing ability in that specific direction and to retain an enhanced sense of audio signal source direction. The signal processing used in accordance with the present invention is based upon known technologies, and various such technologies may be employed in the implementation of the present invention.

The present bone-conductive audio system 10 takes advantage of the fact that soundwaves and their location of origin can be detected by stimulating parts of the pinnae: notably the helix area (on top and to the rear of the outer ear) as well as parts of the tragus area (on the front of the outside ear). These two areas are neurologically related to a perception of sounds emanating from the rear of the head (helix area) and the front of the head (tragus area). It is also known that two areas of bone surround our outer ears. These are the areas of the temporal bone in front of the ear and on top of the jaw and additionally the mastoid portion of the temporal bone behind the ear. These areas also contribute, when stimulated, to the perception of sound source location Front and Rear on that side of the ear area on the head in three-dimensional space.

This provides two different ways to access these abilities of the human anatomy to help provide the hearing-disabled with an increased sense of awareness via auditory and sensory means. The bone-conductive audio system 10 works both on capture of the sound and the playback of the resulting sound simultaneously and in the correct location on the wearer's head to achieve a greater sense of audio localization, depth of perception, speech intelligibility, and safety via increased awareness of accurately captured three-dimensional surroundings.

In the disclosed embodiment, audio is captured live and in real time by the bone-conductive audio system 10 (“Hearing Assist” mode) and played back in the same bone-conductive audio system 10 to the wearer simultaneously. The audio source is derived from a plurality of microphones (that is, the array of microphones 111) strategically and optimally located on the first and second head-worn hearing enhancement apparatuses 100, 102. The microphones face outwards in several directions front and back on the first and second head-worn hearing enhancement apparatuses 100, 102 depending on which side of the head it is worn on.

Audio derived from microphone 112 of the second head-worn hearing enhancement apparatus 100, that is, Channel 1, (the Front Left microphone) would be delivered to the amplified vibration transducer 106 of the first head-worn hearing enhancement apparatus 100 (Front Left transducer). At the same time, microphone 114 of the first head-worn hearing enhancement apparatus 100, that is, Channel 2, located behind the ear on the same side of the head would capture audio that is played back on predominantly the second amplified vibration transducer 108 of the first head-worn hearing enhancement apparatus 100 which corresponds with the location of that corresponding microphone located behind the head in the transducer Channel 2 position. A mixing circuit splits the captured audio from the microphones 112, 114 located on the first head-worn hearing enhancement apparatus 102 into at least two channels of information for each side of the head, left and right, front, and back.

Audio derived from microphone 112 of the second head-worn hearing enhancement apparatus 102, that is, Channel 1, (the Front Right microphone) would be delivered to the amplified vibration transducer 106 of the second head-worn hearing enhancement apparatus 102 (Front Right transducer). At the same time, microphone 114 of the second head-worn hearing enhancement apparatus 102, that is, Channel 2, located behind the ear on the same side of the head would capture audio that is played back on predominantly the second amplified vibration transducer 108 of the second head-worn hearing enhancement apparatus 102 which corresponds with the location of that corresponding microphone located behind the head in the transducer Channel 2 position. In accordance with alternate embodiments a mixing circuit within the processor could be used to split the captured audio from the microphones located on the head-worn hearing enhancement apparatuses into various channels of information for each side of the head, left and right, front, and back.

In accordance with an alternate embodiment, audio could also be split into a third channel that plays directly into the ear canal via a third transducer located in the ear canal. Or mixed into the audio derived from the front and rear Channels 1 and 2. We can call this Channel 3 or the middle channel. There will be a means for adjusting the balance or the relative level between the front and back (and center if utilized) microphones. This would also enable beamforming of the audio pickup pattern by focusing of the pickup pattern via adjustment in the relative volume of each direction. There would also be a mechanism for adjusting the overall volume of the microphones pickup and level adjust for the level of the transducers. Audio SPL Sound pressure level limiting, and audio frequency spectrum isolation circuitry can also be employed.

A further microphone/vibration transducer combination could also be applied to the device with a center channel being placed above the bridge of the nose and a corresponding vibration transducer being located in that location as well to play back the sound captured from that specific location by the microphone onto the bones between the eyes and above the nose. Further, another transducer and microphone combination could be placed on the center-rear of the head to playback sounds captured from microphones in that location. This would complete the 360-degree audio pickup and playback via vibration transducers although it may be impractical to wear such a device in most circumstances.

In summary, the present invention provides an electronic hearing device comprised of a frame that fits over a single human outer ear, designed specifically for wearing on the left or right side of the head, and that includes at least two amplified audio transducers that reproduce audio signals, with both transducers mounted on the same frame, one located in front of the ear and one located behind the ear, and that are provided audio from at least two individual channels of audio sources simultaneously, and play back the audio channels through the front and rear transducers at the same time.

A variety of set-ups are contemplated. For example, the electronic hearing device can include more than two microphones per side and have more than two playback channels per side; the two channels may contain discrete audio information or a blend of information comprised of audio signals derived from all microphones simultaneously; and two units can be paired to each other via wires or wirelessly to function binaurally by using two individual devices, one specifically designed for (and worn on) each ear left and right, simultaneously. Further still, the electronic hearing device can be paired to a smartphone etc., to be controlled by an application; can receive Bluetooth audio files from multiple sources: tv, phone, communications etc.; can decode multi-channel audio to provide at least 4 channels of playback; can control overall volume; control balance left and right between two units; can adjust frequency bandwidth characteristics; can blends the signals giving emphasis to one mic over the other; can decode multi-channel audio to provide at least 4 channels of playback.

What makes it all work together as a system is the organic physical interaction between both the capture side of the system and the playback side—the magic is in putting these things together. The human head itself acts as a barrier for incoming audio sound waves that bend around the curves of our head and our face, and audio is simultaneously captured by the different microphones at slightly different timings and amplitudes from each other individually resulting from the sound wave interacting with the physical form of the head; amounting to the correspondingly captured and spatially-derived audio being delivered directly to the corresponding playback transducer located within that same corresponding contact region as the assigned capture microphone supplying it.

All the timing and amplitude audio information captured by the microphones is left intact within the individual audio signals. When the discreet signals are played back simultaneously to the playback transducers, the combination of these signals is automatically and directly perceivable by our brains as correct spatial audio information—even to a deaf person!

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of means or step plus function elements in the claims below are intended to comprise any disclosed structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. For example, this disclosure comprises possible combinations of the various elements and features disclosed herein, and the particular elements and features presented in the claims and disclosed above may be combined with each other in other ways within the scope of the application, such that the application should be recognized as also directed to other embodiments comprising other possible combinations. The aspects of the disclosure herein were chosen and described in order to best explain the principles of the disclosure and the practical application and to enable others of ordinary skill in the art to understand the disclosure with various modifications as are suited to the particular use contemplated.

While the preferred embodiments have been shown and described, it will be understood that there is no intent to limit the invention by such disclosure, but rather, is intended to cover all modifications and alternate constructions falling within the spirit and scope of the invention.

1. A bone-conductive audio system, comprising:
at least one head-worn hearing enhancement apparatus comprises at least one microphone in front of the outer ear generally picking up sound in a forward outward direction and at least one microphone behind the outer ear picking up sound in a more rearward outward direction;
first and second amplified vibration transducers that interact with the at least one microphone in front of the outer ear and the at least one microphone behind the outer ear, the first and second amplified vibration transducers being drawn toward audio conductive bones;
wherein placement of the at least one microphone in front of the outer ear and the at least one microphone behind the outer ear feeds the naturally captured discrete audio signals, front and rear, captured in a physical location on the head to the first and second amplified vibration transducers to create organically recognizable audio spatiality.

2. The bone-conductive audio system according to claim 1, wherein the at least one head-worn hearing enhancement apparatus includes a first head-worn hearing enhancement apparatus adapted for positioning adjacent to the left ear of the user and a second head-worn hearing enhancement apparatus is adapted for positioning adjacent to the right ear of the user.

3. The bone-conductive audio system according to claim 2, wherein the first and second head-worn hearing enhancement apparatuses are connected via a resilient biased band that is shaped and dimensioned for positioning about the head of the user, wherein the resilient biased band draws the first and second head-worn hearing enhancement apparatuses toward each other such that the first and second amplified vibration transducers are drawn into contact with skin of the user in alignment with bone to which vibrations are transferred.

4. The bone-conductive audio system according to claim 2, wherein the second head-worn hearing enhancement apparatus is an approximate mirror image of the first head-worn hearing enhancement apparatus.

5. The bone-conductive audio system according to claim 1, wherein the first amplified vibration transducer is placed above the bone, superficial to the skin on the front of the ear such that the first amplified vibration transducer vibrates the area in front of the tragus and also vibrates on the front part of the temporal bone as well as simultaneously stimulating the tragus area nervous system, and wherein the second amplified vibration transducer is placed behind the ear simultaneously stimulating the rear portion of the mastoid bone and the tactile nervous system towards the rear of the ear.

6. The bone-conductive audio system according to claim 1, wherein the at least one head-worn hearing enhancement apparatus includes an over the ear mounting frame.

7. The bone-conductive audio system according to claim 6, wherein the over the ear mounting frame includes an arcuate central support member that is shaped and dimensioned for engagement between the helix of the ear and the area of the scalp adjacent the helix of the ear.

8. The bone-conductive audio system according to claim 7, wherein the arcuate central support member includes a first end adapted for positioning toward the front of the ear and a second end adapted for positioning toward the rear of the ear.

9. The bone-conductive audio system according to claim 8, wherein an anterior first housing member is coupled at the first end of the arcuate central support member and a posterior second housing member is coupled at the second end of the arcuate central support member.

10. The bone-conductive audio system according to claim 9, wherein the first amplified vibration transducer is mounted on the over the ear mounting frame within the anterior first housing member such that it is positioned at the front of the outer ear on the front portion of the temporal bone and touching the Tragus area of the outer ear, and the second amplified vibration transducer is mounted on the over the ear mounting frame within the posterior second housing member such that it is behind the outer ear on the rear portion of the temporal bone.

11. The bone-conductive audio system according to claim 10, wherein the at least one microphone includes an array of microphones placed on the perimeter of the over the ear mounting frame.

12. The bone-conductive audio system according to claim 11, wherein the array of microphones includes a first microphone mounted within the anterior first housing member such that the first microphone faces a predominantly forward direction and provides audio to the first amplified vibration transducer in the front of the ear and the array of microphones includes a second microphone mounted within the posterior second housing member such that the second microphone faces outward and away from the rear of the ear when the first head-worn hearing enhancement apparatus is in use and provides audio that is delivered to the second amplified vibration transducer in the rear of the ear.

13. The bone-conductive audio system according to claim 1, wherein the at least one microphone includes an array of microphones.

14. The bone-conductive audio system according to claim 1, wherein the at least one head-worn hearing enhancement apparatus includes a portable power source.

15. The bone-conductive audio system according to claim 14, wherein the power source is a rechargeable or replaceable battery.

16. The bone-conductive audio system according to claim 1, wherein the at least one microphone captures live audio information and simultaneously plays back incoming multi-channel and multi-directional audio information over the first amplified vibration transducer and the second amplified vibration transducer, respectively, along the front and rear portions adjacent the ear.

17. The bone-conductive audio system according to claim 1, wherein the at least one head-worn hearing enhancement apparatus includes a battery, electronics, processing, and controls.

18. The bone-conductive audio system according to claim 1, wherein magnets are integrated into the at least one head-worn hearing enhancement apparatuses such that they interact with subdermal bone-mounted magnets or metal plates to draw the at least one head-worn hearing enhancement apparatuses into contact with the skin of the user in alignment with the bone to which vibrations are transferred.

19. A bone-conductive audio system, comprising:
at least one head-worn hearing enhancement apparatus comprising at least one microphone located near the outside of the ear generally picking up sound in an outward direction;
an audio splitter that multiplies the incoming audio signal derived from the at least one microphone into at least two signals creating a secondary audio signal; and
a first amplified vibration transducers that interacts with the at least one microphone on the outer ear directly, the first and second amplified vibration transducers being drawn toward audio conductive bones; one in front of and one behind the outer ear;
wherein placement of the at least one microphone outside of the outer ear feeds the naturally captured discrete audio signal to the front playback transducer and the secondary audio signal to the rear transducer, to create recognizable audio spatiality.

20. The bone conductive audio system according to claim 19 includes an audio processor that delays the at least one secondary incoming audio signal by one to fifty milliseconds and send its time-delayed audio signal to the second vibration transducer to create recognizable spatial audio.

21. The bone conductive audio system according to claim 19 includes an audio processor that increases the relative volume of audio frequencies between 1 kHz and 5 kHz of the at least one secondary incoming audio signal and sends its modified audio signal to the second vibration transducer to create a recognizable spatial audio.

22. A bone-conductive audio system comprising:
at least one head-worn hearing enhancement apparatus comprising at least one microphone located near the outside of the ear generally picking up sound in an outward direction; and
first and second amplified vibration transducers that interact with the signal provided by at least one microphone on the outer ear and a secondary audio signal, the first and second amplified vibration transducers being drawn toward audio conductive bones, one in front of and one behind the outer ear;
wherein placement of the at least one microphone outside of the outer ear feeds the naturally captured discrete audio signal to the front playback transducer and a secondary audio signal is supplied to the rear transducer.
